(19) United States
(12) Patent Application Publication
(10) Pub. No.: US 2003/0046345 A1
(43) Pub. Date: Mar. 6, 2003

(54) System and method for project management

(76) Inventors: Makoto Wada, Kanagawa (JP); Yuichiro Yamada, Tokyo (JP); Saomi Shimmura, Tokyo (JP)

Correspondence Address: McGinn & Gibb, Suite 200, 8321 Old Courthouse Road, Vienna, VA, 22182-3817, US

(21) Appl. No.: 10/089,513

(22) PCT Filed: Jul. 31, 2001
(86) PCT No.: PCT/JP01/06610

(30) Foreign Application Priority Data
Aug. 1, 2000 (JP) 2000-233750

(51) Int. Cl. G06F 15/16

(52) U.S. Cl. 709/205; 709/203

(57) ABSTRACT

A project management system is disclosed which is easy to use by members belonging to a project and other persons. The system comprises a server 2 and a DB 3 which stores project by project, contents belonging to those projects participated in by some or all of users. The server 2 comprises a communication controller 4 for transmitting prescribed pages to user terminals 1 and receiving operation messages from the pages, a project desktop sheet generator 10 for reading out contents data from the database 3 in response to those operation messages and generating pages for displaying or accessing all the contents belonging to those projects, project by project, as project desktop sheets, and an access controller 12 for controlling communications with user terminals, when there has been an access made via the communication controller 4 for the content of the contents, in unit of project desktop.

### TECHNICAL FIELD

This invention relates to a project management system, and particularly to a project management system for supporting project-related information management.

### BACKGROUND ART

Conventionally, when a company is engaged in a project involving the development of a new product or advertising initiative, or a new research initiative is undertaken by a university or other research institution, the work of deciding the details of such projects is done mainly through the exchange of written documents or aurally in conferences. In recent years, with the development and proliferation of information technology, functions have been provided for holding electronic forums, managing the progress of groups, and sharing electronic document files. Project members make use of information technology, in conjunction with the carrying on of the project, to utilize electronic forums and store document files that share a directory specified by groupware.

In Japanese Patent Application Laid-Open No. A-8-30577/1996, for example, techniques are disclosed for maintaining the integrity of information on the manager side and on the person-in-charge side when the project manager takes such discretionary actions as adding jobs or changing persons in charge. In Japanese Patent Application Laid-Open No. A-11-143912/1999, moreover, techniques are disclosed for using various indexes for searching document collections corresponding to electronic forums.

Unfortunately, however, in the conventional examples cited above, statements and document files relating to a single project must be managed using respectively different software packages. Also, when multiple projects are being carried on in parallel, in order to store or read out necessary document files or participate in an electronic forum, the electronic location where such operations are conducted must first be searched out, project by project.

When forums and document management are conducted project by project, furthermore, because the participating members and their roles will be different in each project, there is a problem because user-oriented access rights management becomes complicated and troublesome.

### DISCLOSURE OF INVENTION

An object of the present invention is to overcome the difficulties associated with the conventional examples, and more particularly to provide a system and method for project management that are capable of easily managing the registration and searching of information relating to projects.

Another object of the present invention is to provide a system and method for project management that, in cases where multiple users having pre-assigned log-in IDs participate in multiple projects within an organization such as a company or research laboratory, are capable of managing the sharing of information for each of the projects and supporting the management of project advance.

The present invention comprises a server connected through a network to a plurality of user terminals (or client computers) controlled respectively by a plurality of users, and a database wherein are stored contents belonging to projects, project by project, participated in by some or all of the plurality of users.

The server, moreover, comprises a communication controller for transmitting a prescribed page to a user terminal and also receiving operation messages from the page or executed buttons on the page, and a project desktop sheet generator (PJ-DT sheet generator) for reading out contents data from the database in accordance with operation messages received by that communication controller and generating pages for displaying or accessing all the contents belonging to those projects, project by project, as project desktop sheets (PJ-DT sheets). The server also comprises an access controller for controlling communications with user terminals, when there has been an access made via the communication controller for the content of the contents, in unit of project desktop containing those contents. In this manner the problems noted earlier are to be resolved.

The database, for each project, stores the contents belonging to that project. The contents consist of various kinds of data and files handled in that project, such as project title data, text data, list data, image data, voice data, document files, statements made in forums, scrap books, schedule data, update history data for information for each project, and chart data (member lists) for members belonging to that project.

The access controller, when content of the contents has been accessed, as in a contents content search, or a project access by user name when there is a member list, controls communications with the user terminals in units of project desktops including those contents. The access controller may also be configured so that it generates a link to a project desktop containing the contents at issue, in situations where a project is retrieved. Or, in a situation where a project has been specified, and the contents thereof are to be displayed, the access controller may be configured so that it causes the project desktop sheet generator (PJ-DT sheet generator) to generate a project desktop.

The access controller, when contents have been searched, for example, causes a project desktop title (PJ-DT title) containing those contents to be displayed as the search results. The display of that project desktop title can be made a link for displaying that project desktop. Or, when a list of projects to which some user belongs is to be displayed, it is only necessary to cause a list of project desktop names to be generated with that user name made the contents of the project. When a display instruction has been received for some project desktop, after (a) project desktop(s) has/have been specified from various entrances, the access controller causes the project desktop sheet generator to generate the project desktop selected and specified by the display instruction.

The project desktop sheet generator (PJ-DT sheet generator) reads out contents data from the database and also generates pages for displaying or accessing all of the contents belonging to a program at issue, program by program, as project desktop sheets. Thus a user, using a project desktop, can view all information (contents) relating to that project, and can also input or register new information relating thereto.

For example, when a list of project titles, the search results of a full text search of a document file, the names of contents displayed on individual desktops or the like user by user, or a project title that is one type of contents has or have been operated on so that such may be displayed, the project desktop sheet generator (PJ-DT sheet generator) generates a project desktop in which are aggregated the contents belonging to the project, as controlled by the access controller. Thus it is easy to effect management, project by project, in order to register, update, or review data or files used in a project, in units of project desktops, even when multiple projects are running in parallel.

In the present invention, the access controller performs control to cause the project desktop sheet generator to generate a project desktop when the contents of a project have been accessed, as in an access from a list of project names, a search of contents content, or an access by user name when there is a member list, etc. Thereupon, the project desktop sheet generator reads out contents data from the database, and also generates pages, project by project, for displaying or accessing the entire contents belonging to those projects, as project desktop sheets. Thus, a user, using a project desktop, can view all of the information (contents) relating to that project, or input or register new information relating thereto.

For example, when a list of project titles, the search results of a full text search of a document file, the names of contents displayed on individual desktops or the like user by user, or a project title that is one type of contents has or have been operated on so that such may be displayed, the project desktop sheet generator can generate a project desktop in which are aggregated the contents belonging to the project, as controlled by the access controller.

In this manner, with the present invention, an outstanding project management system not previously available can be provided that can easily manage information project by project, for the purpose of registering, updating, and viewing data and files used in projects, in project desktop units, even when multiple projects are running in parallel.

### BRIEF DESCRIPTION OF DRAWINGS

FIG. 1 is a block diagram representing the configuration of one embodiment aspect of the present invention;

FIG. 2 is an explanatory diagram representing one example of a project desktop sheet used in the embodiment aspect diagrammed in FIG. 1;

FIG. 3 is a block diagram representing a detailed configurational example of the project desktop sheet generator (PJ-DT sheet generator) indicated in FIG. 1;

FIG. 4 is an explanatory diagram representing a configurational example, etc., in a case where contents are being searched, with FIG. 4(A) being a diagram representing a detailed configurational example of the access controller diagrammed in FIG. 1, and FIG. 4(B) being a diagram representing an example of a display format for search results;

FIG. 5 is a flowchart representing an example of project-related information management in this embodiment aspect;

FIG. 6 is a flowchart representing one example of a processing routine for generating a project desktop sheet (PJ-DT sheet);

FIG. 7 is a block diagram representing an example configuration of hardware in this embodiment aspect, with FIG. 7(A) being a diagram of one example of server hardware resources, and FIG. 7(B) being a diagram of an example configuration when the network is made the internet or an intranet;

FIG. 8 is a block diagram of an example configuration of one example according to the present invention;

FIG. 9 is an explanatory diagram showing how the pages are to be connected according to the example diagrammed in FIG. 8;

FIG. 10 is an explanatory diagram representing one example of a project desktop sheet in this example;

FIG. 11 is an explanatory diagram representing a continuation of the project desktop sheet diagrammed in FIG. 10;

FIG. 12 is an explanatory diagram showing the relationship between user attributes and attribute-oriented access rights for a project in this example;

FIG. 13 is an explanatory diagram of one example of a data structure used in the configuration diagrammed in FIG. 8;

FIG. 14 is a flowchart representing one example of user attribute determination processing in the configuration diagrammed in FIG. 8;

FIG. 15 is an explanatory diagram representing a specific project desktop display example in this example;

FIG. 16 is a flowchart representing one example of a project desktop display processing routine in the configuration diagrammed in FIG. 8;

FIG. 17 is an explanatory diagram of one example of a page for producing a project desktop in this example, with FIG. 17(A) being a diagram representing one example of a page for project production and FIG. 17(B) being a diagram representing one example of an initial screen on the project desktop in this example;

FIG. 18 is an explanatory diagram of one example of a text entry page for inputting text;

FIG. 19 is an explanatory diagram of one example of a project editing page;

FIG. 20 is an explanatory diagram representing an example of adding a bookshelf section to a project desktop in this example;

FIG. 21 is a block diagram representing an example configuration of the save controller and search controller indicated in FIG. 8;

FIG. 22 is an explanatory diagram representing an example of the display of search results for document content or the like in this example;

FIG. 23 is a flowchart representing one example of a search processing routine according to this example;

FIG. 24 is an explanatory diagram representing one example of saving a project desktop sheet in this example, with FIG. 24(A) being a diagram of an example page for selecting the project to be saved and FIG. 24(B) being a diagram of an example page for downloading a saved project desktop file (bookshelf file);

FIG. 25 is a flowchart representing one example of a save processing routine according to this example;

FIG. 26 is an explanatory diagram of one example of a project list page according to this example;

FIG. 27 is an explanatory diagram of one example of a project list page according to this example;

FIG. 28 is an explanatory diagram of one example of a member list according to this example;

FIG. 29 is an explanatory diagram representing the general course of processes up until a project desktop is completed according to this example;

FIG. 30 is an explanatory diagram representing an example of accessing a project desktop according to this example; and

FIG. 31 is a flowchart representing an example of using the project management system according to this example.

### BEST MODE FOR CARRYING OUT THE INVENTION

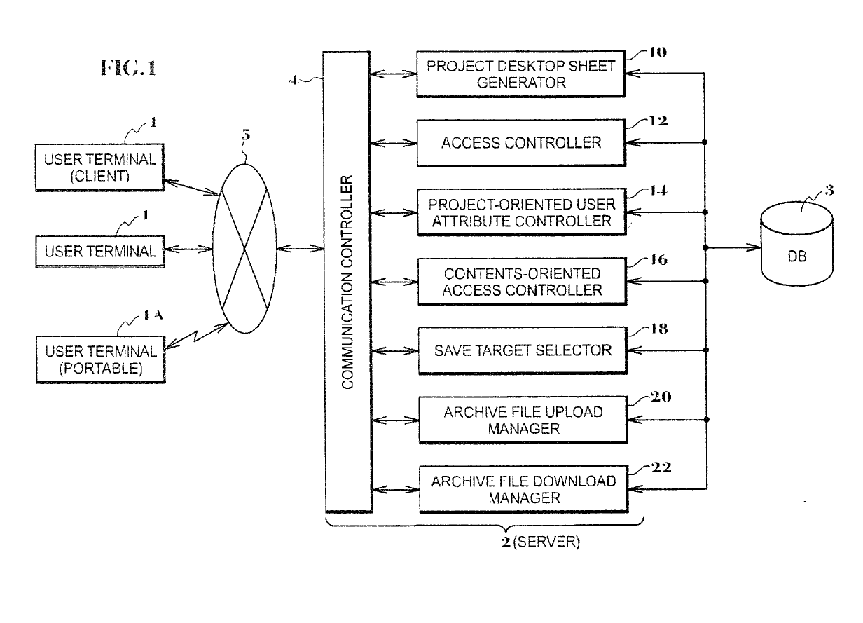

An embodiment aspect of the present invention is described now with reference to the drawings. FIG. 1 is a block diagram representing the configuration of one embodiment aspect of the present invention. The project management system according to this embodiment aspect is a system that supports activities in units of member projects. This system comprises a server 2 to which are connected, by a network 5, a plurality of user terminals 1 operated respectively by a plurality of users, and a database (DB) 3 wherein are stored contents belonging project by project to projects participated in by some or all of the plurality of users.

The server 2, moreover, comprises a communication controller 4 for transmitting a prescribed page to the user terminals 1 and also receiving operation messages from the page or executed button on the page, a project desktop sheet generator (PJ-DT sheet generator) 10 for reading out contents data from the database 3 in accordance with operation messages received by the communication controller 4 and generating pages for displaying or accessing all the contents belonging to those projects, project by project, as project desktop sheets (PJ-DT sheets), and an access controller (or PJ-DT oriented access controller) 12 for controlling communications with user terminals, when there has been an access made via the communication controller 4 for the content of the contents, in unit of project desktop containing those contents.

The user terminals 1 are computers such as personal computers, or portable terminals 1A such as portable telephones. These user terminals comprise displays, and display pages written in a page description language such as a markup language (ML, HTML or XML). The server 2 generates this page information (ML pages), and transmits the same to the user terminals 1 via the communication controller 4. The pages generated by the server 2 comprise user interface such as execution buttons for operations, such as edit buttons, setting buttons, and links. The users manipulate the edit buttons and links and the like on pages transmitted from the server 2 to display new pages, upload or download document files, and effect various settings relating to access rights and the display, etc.

The network 5 is an information transmission medium such as the internet, an intranet, or a dedicated intra-organizational network or the like. The communication controller 4 consists of hardware and software for controlling communications between the user terminals 1 using a prescribed communications protocol. The server 2 is a computer for executing the server software.

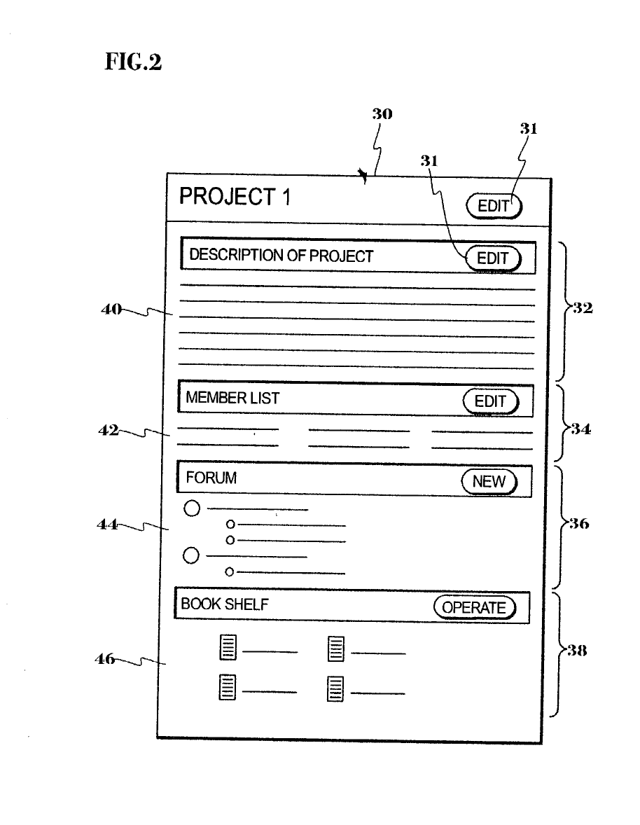

The project desktop sheet generator 10 constitutes a portion of the functions of the server 2 for generating various pages. The project desktop comprises sections such as a member list section 42 that is a list of project members and a bookshelf section 46 that constitutes document managing contents, as diagrammed in FIG. 2. In this embodiment aspect, this project desktop is produced for each project. In this system, contents necessary to a project are input or registered, and contents search results are displayed, in unit of project desktop, as diagrammed in FIG. 2.

In this embodiment aspect, when access is made to contents via the communication controller 4, the access controller 12 controls communications with the user terminals 1 in unit of project desktop that contain those contents. The access controller 12, when contents contained in a project are accessed, generates the project desktop containing those contents, and also displays a link. The access controller 12 also controls write or read access for each user to the project desktop overall, based on access rights established in project desktop units. Thus the unified management of information pertaining to projects is made possible, and, even in cases where multiple users are participating in many projects, users can easily access necessary information while the access rights to information pertaining to the projects are being controlled.

An instruction to access contents is transmitted, for example, when an edit button or link or the like has been clicked on at a user terminal 1, from that user terminal 1 to the communication controller 4. The generic term execution button is used here for the control operation displays, such as the edit buttons, operation buttons, and links to other pages, that are displayed on the project desktop and in the contents sections.

Links to other pages effected in HTML, for example, are execution buttons. By these execution buttons, other page names and program (script) names for driving the server 2 are defined; the communication controller 4 receives those program names and necessary values and inputs them to the server 2. In the server 2, when an access is made to project contents, the access controller 12 responds. At that time, the access controller 12 causes the project desktop sheet generator 10 to generate a project desktop such as that diagrammed in FIG. 2, for example.

As indicated in FIG. 2, a project desktop 30 contains a plurality of sets of contents. In the contents are contained such items as the project title, the text section for managing texts representing particulars of the project, the member list section 42 for managing the member list 42 that lists the members participating in the project, a forum section 36 for managing a forum 44, a bookshelf section 38 for managing various kinds of file groups 46, a scrap book section (not shown), a bulletin board section (not shown), a schedule or calendar section (not shown) for managing the project schedule, and a multi text section for managing texts, graphics and files (not shown). In the calendar section, provision may be made for causing the project calendar to interact with calendars for each user. These various types of contents sections are added to the project desktop by the project leader or members. Each contents section is an inner window in a project desktop sheet.

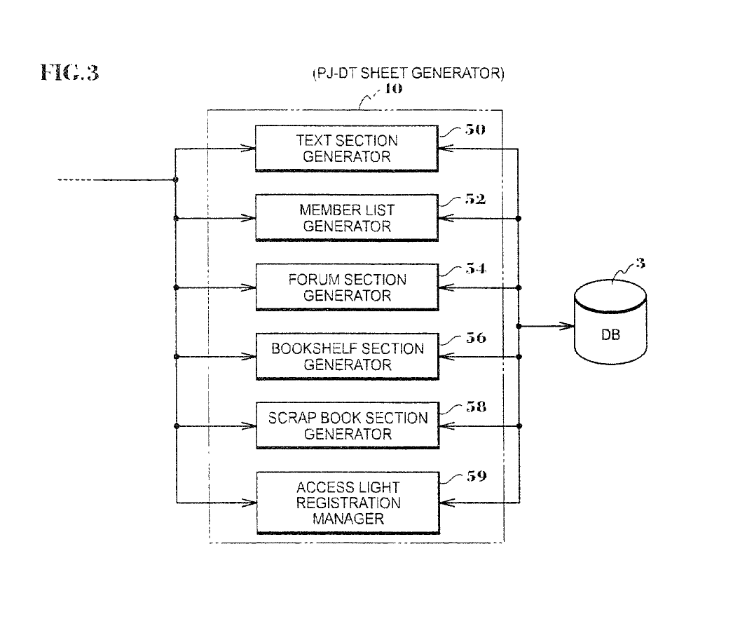

The project desktop sheet generator 10, when it generates a project desktop, reads out contents contained in that project desktop from the database 3 and generates contents sections. Then, each contents section is synthesized in a single-page sheet as diagrammed in FIG. 2 and that is made the project desktop 30. Thus the project desktop sheet generator 10, as diagrammed in FIG. 3, comprises a text section generator 50 for managing text for making summary descriptions of the project, and the like, a member list section generator 52 for generating, as contents, a member list section for managing a list of members included in the project, and a forum section generator 54 for generating a forum section, as contents, for recording or displaying the statements or replies of users, in accordance with user attribute-oriented access rights managed by a contents-oriented access controller.

The project desktop sheet generator 10 also comprises a bookshelf section manager 56 for managing, as contents, both the bookshelf section 38 for registering or downloading document files, and the document files 46 registered in that bookshelf section 38, in accordance with the user attribute-oriented access rights managed by the contents-oriented access controller 16.

The project desktop sheet generator 10 may also comprise a scrap book section manager 58 in which to paste news articles and images and the like pertaining to the project. These functions may be made so that they are sequentially provided in conjunction with the course of the development of the project management system. In an example wherewith the project desktop title is appended to a personal desktop or user list, the member list 42 becomes mandatory. It is believed, moreover, that the bookshelf section 38 plays a major role in supporting project activities. The various contents section generators 50, 52, . . . , 58 add operation or execution buttons such as the edit buttons 31 indicated in FIG. 2, or links, etc., to the sections in accordance with prescribed access rights, etc.

In the example diagrammed in FIG. 3, the project desktop sheet generator 10 comprises an access rights registration manager 59 that, when the various contents are generated, prompts the user doing that generation operation to set the user attribute-oriented access rights to those contents.

When the edit buttons 31 indicated in FIG. 2 are operated, the server 2 transmits a page for making additions to the content of the project desktop or the contents sections, or display-related settings and the like, to the user terminal. By creating such a project desktop as this for each project, the current status of a plurality of projects can be recognized at a glance. In the example diagrammed in FIG. 2, furthermore, there is no need to jointly use multiple software packages in order to conduct work relating to a project. A new file can be registered in the bookshelf section 38, for example, and a summary thereof or the like given as a statement in the forum 44, so that the contents sections are used in an integrally associated fashion and not as individual functions. That being so, it is possible to concentrate on the work required in advancing the project, without needing to spend time in switching or starting up software, or in retrieving a suitable location or the like.

Moreover, in generating user-oriented pages (called here personal desktops), and in displaying search results after searching for objects that are the content of the various contents (such as a project title, member name, full text of a document registered in the bookshelf section, or a statement made in a forum), those operations are not based on the several contents, but are performed in units of project desktops like that diagrammed in FIG. 2. Thus, because it is possible to specify the project to which the contents belong that came up as search results, it also being possible to effect processing so as to continually display a list of projects to which that user belongs on his or her personal desktop, it becomes easy to access information pertaining to those projects.

Thus, in this embodiment aspect, when an access has been made to contents, the access controller 12 controls communications with the user terminal 1 in units of project desktops containing those contents. The access controller 12 also causes the content of contents to be displayed in project desktop units, not only when a project desktop display instruction has been effected, but also when those contents have been searched for, or when a list of project titles is displayed, or when a list of users is displayed, or when a personal desktop is displayed, or otherwise when access is made to such contents as a project title or member list. In other words, when a display request or search has been made using information, relating to a project, already registered as a key, the access controller 12 causes such information to be displayed on the basis of a project desktop diagrammed in FIG. 2. In a preferred embodiment aspect, this project-desktop-based display also comprehends cases where the project desktop title is displayed as a link-based operation button.

In this embodiment aspect, the server 2, as diagrammed in FIG. 1, comprises a project-oriented user attribute detector 14 for determining user attributes for projects, of the leader or a member or the like of a project, which are set for users project by project, and communicated via the communication controller 4, and the contents-oriented access controller 16 that is for controlling the content of operations on a project desktop based on the user attributes determined by that project-oriented user attribute detector 14 and on the access rights for each user attribute predetermined for each of the sets of contents for the projects.

The user attribute is a user role for a project, such, for example, as that of a log-in user who has logged onto the server 2 diagrammed in FIG. 1, or, when a certain project is in view, that of a member participating in that project, or that of a leader who, among such members, plays a central role in that project. For example, a certain user might be a member in project A, both a member and the leader in project B, and a non-member, non-participating log-in user in project C. User attributes are set for each project. With respect to users during a session communicated via the communication controller 4, as concerning a project which a user tries to access during that session, the project-oriented user attribute detector 14 determines the user attributes, such as leader or member or the like, for that project, which have been set project by project beforehand.

Also, in a preferred embodiment aspect, user-oriented access rights are set for each set of contents of a project. The setting of these access rights, moreover, is not made by user name, but rather on the basis of user attributes. Accordingly, settings are made for members, such as to allow reads but disallow writes, for example, whereupon any user, so long as he or she is a member, can use those access rights. Thus, by controlling the access rights to the various contents on the basis of project-oriented user attributes, it becomes easy to set access rights, and the setting and use of such rights is made easy to understand by project participants and information registering parties. Thus a project leader is able to manage access rights in a definite manner without performing onerous operations.

The contents-oriented access controller 16 controls the content of operations done on the project desktop, based on the user attributes determined by the project-oriented user attribute detector 14 and on the user attribute-oriented access rights predetermined for each set of contents. Consider, for example, a case where, for a particular project, settings are made so that a log-in user other than a member will be able to participate in forum sessions, but not allowed to download document files from a bookshelf section. In this example, if the user attribute for a user in a session is a non-member log-in user, based on the access rights described above, while being allowed to issue statements to a forum, he or she will be prohibited from downloading document files registered in the bookshelf section. Because the access rights are determined by user attribute, there is no need whatever to reset access rights when a log-in user is newly added. Nor is there any need to reset access rights when a log-in user is registered as a member, or when such is removed from membership. Also, a situation wherein the access rights differ from one project to another, even for the same log-in user, can be managed well, merely by establishing such user attribute-oriented access rights as these for each set of contents for each project.

In particular, by determining a project leader, and granting that leader the authority to set access rights, it becomes possible to conduct autonomous access rights management. That is, by setting user attribute-oriented access rights for each set of contents, the security of information relating to a project can be safeguarded without requiring a special manager.

Provision can be made so that the contents-oriented access controller 16 controls the access to contents sections by user attribute, specifically by limiting the functions of the edit buttons 31 indicated in FIG. 2, operation buttons, or production buttons or the like. Thus user attribute-oriented security management is made possible that does not involve setting access rights for each individual file.

In a preferred embodiment aspect, furthermore, a save function for saving a project desktop may be comprised. In the example diagrammed in FIG. 1, the server 2 comprises a save target selector 18 for setting one or more projects of a plurality of targets as save targets, an archive file upload manager 20 for archiving the contents included in the one or more of the project desktops set by the save target selector 18, in one archive file, and an archive file download manager 22 for transmitting an archive file archived by that archive file upload manager 20, in response to an operation at a user terminal, to that user terminal.

In this example, saving is done in project desktop units in the course of project advance and at the completion stage and the like. By saving in units of project desktops, a project desktop can be used to make an announcement to the outside, and all information pertaining to a project can be saved in one place. When this saving is done such that information is saved as page information using a markup language, a home page can be effected to the outside by registering that project desktop on a web server.

In the example diagrammed in FIG. 1, moreover, because the file group 46 accumulated in the bookshelf section is saved in an integrated manner, files pertaining to the project desktop are archived. This archiving is particularly useful when there is a bookshelf section 38. That is, the archive file upload manager 20 archives the contents contained in one or more project desktops set by the save target selector 18, in one archive file. When a single project desktop is to be saved, for example, a page describing the overall project desktop, a page that separately stores forum statements and the like, document files held in the bookshelf section 38, and image files and the like used in displaying the project desktop are archived in a single folder. When that is done, the archive file upload manager 20 rewrites a link to a page wherein the document files, images files, and/or statements and the like are described. In a preferred example, the archive file upload manager 20 may comprise a compression function for compressing archived files.

The archive file download manager 22 transmits archive files archived by the archive file upload manager 20 to user terminals in response to user terminal operations. Such transmission may be done by rendering an archive file into a downloadable condition and then prompting the user to effect a download operation, or by saving that archive file on a floppy disk and sending it by mail.

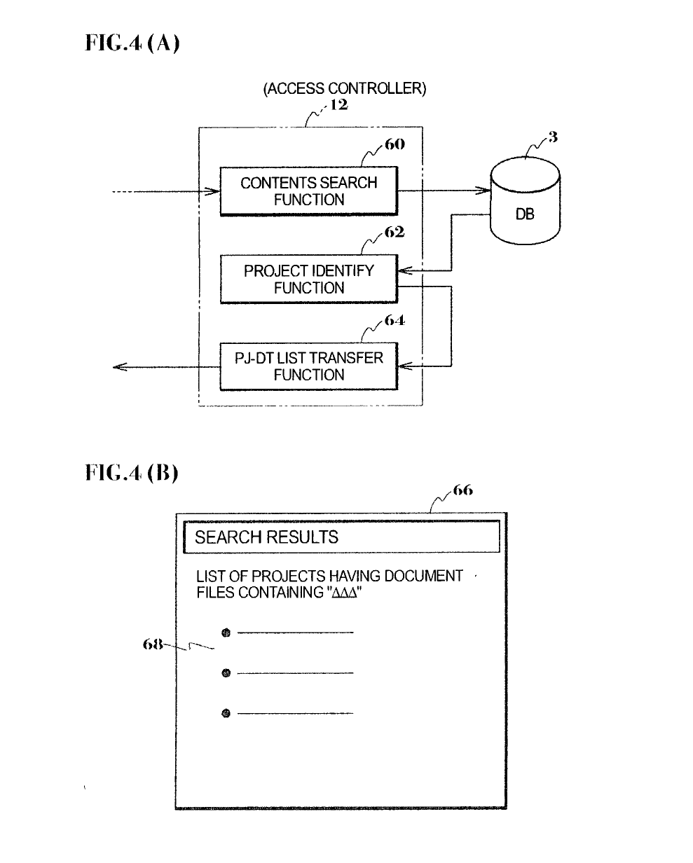

FIG. 4(A) is a block diagram representing an example case where various contents of multiple projects are searched transversely. In the example diagrammed in FIG. 4(A), the access controller 12 comprises a contents search function 60 for searching one or a plurality of sets of contents containing data that match data entered at a user terminal, a project identify function 62 for identifying the projects to which the several contents searched by the contents search function 60 belong to, and a PJ-DT list transfer function 64 for transmitting a list of project desktops of projects identified by the project identify function 62, to user terminals, as search results.

The contents search function 60 performs full text searches and the like of text in a text section, statements in a forum, and document files registered in the bookshelf section, for example. The project identify function 62 identifies a project to which certain contents belong, namely contents searched by the contents search function 60, from those contents or from the elements configuring those contents. And the PJ-DT list transfer function 64 transmits a list of project desktops of projects identified by the project identify function 62, to user terminals, as search results. FIG. 4(B) is an explanatory diagram of one example of such search results. Here, a project list 68 is displayed that has a document file containing the text characters ΔΔΔ. The user, from these search results, can access both that document file itself, and the project desktop that is a list of information relating to the project wherein that document file was created. By displaying the project desktop containing those searched contents, it becomes easy for a user to access information exhibiting a high correlation with the search target, and also easy for that user to comprehend the process by which that document file or text data were created and the purpose for such creation.

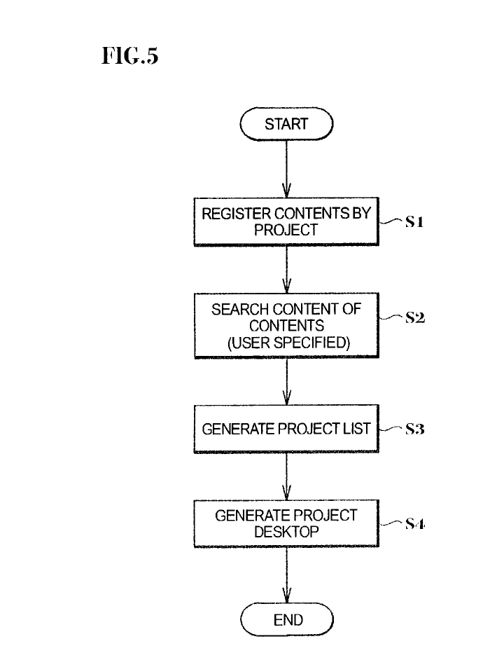

FIG. 5 is a flowchart representing an example of project-related information management (project management method) with the configuration diagrammed in FIG. 1, etc. In the example diagrammed in FIG. 5, the project management system diagrammed in FIG. 1, etc., is used to support the generation and management of project-related data. First, the contents contained in each project are registered, project by project (step S1: project-oriented contents registration step). Following that, when one or a plurality of sets of registered contents have been searched or accessed by a member belonging to the project (step S2), those several contents or a list of projects including that member is generated (step S3: project list generation step). Then, when a project display request has been made by a user in response to the project list generated by the project list generation step S3, a page for displaying or accessing all contents contained in that project is generated as a project desktop (step S4: project desktop generation step).

There are two cases for an access which will be the object of generating a project list in step S3, namely the case where one or a plurality of sets of registered contents have been searched, and the case where access has been made concerning members belonging to a project. The display of a project desktop list resulting from members being accessed includes, for example, cases where the titles of projects to which members belong are displayed when a member list is generated, cases where a list of projects to which a certain user or users belong is displayed on user-oriented desktops, and cases where a search was made with a specific user name, etc. Contents are searched in the same way as in the case diagrammed in FIG. 4.

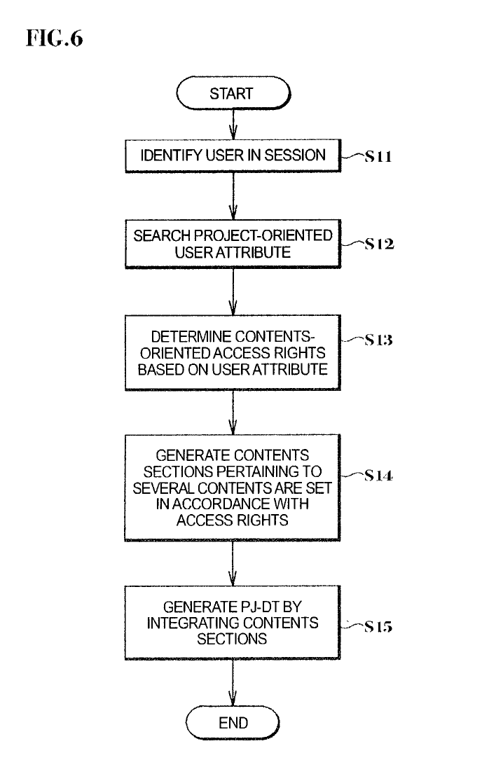

FIG. 6 is a flowchart representing one example of the project desktop (PJ-DT) generation process S4. In the project desktop generation step S4, as diagrammed in FIG. 6, first, the log-in ID and the like of the user who made the display request are identified (step S11), and, following thereupon, the user attribute is determined to establish whether or not that user is a member of the project in view in the display request (step S12: project-oriented user attribute determination step). Then a display and an operation are determined for allowing that user access to the several contents according to the user attribute-oriented access rights predetermined for each set of project contents requested to be displayed and to the attribute of the user who made that display request (step S13: contents-oriented rights determination step). Then, the contents sections are generated in accordance with the rights relating to display and operations determined in that contents-oriented rights determination step, and a page wherein those contents sections are integrated is generated as a project desktop (step S15: contents section integrated page generation step).

In step S11, log-in IDs and user IDs and the like in the session are fetched from the system. In step S12, from such user ID or log-in ID, the user attribute of a leader or member or the like for the project for which display is being requested is determined. Display requests include cases where a link to a project desktop based on the project title has been operated, as well as cases where the project title is displayed as search results. In a particular example, for instance, in a case where a project leader has completely prohibited access to the project desktop by anyone other than a member, provision is made so that no link to that project desktop is displayed even assuming that a search has been made in the contents or the like.

In step S14, when a project desktop is actually generated, the generation of the several contents of the project desktop is controlled in accordance with the user attribute-oriented access rights determined for each project and for each set of contents. In step S15, the project desktop is generated, by integrating the contents sections generated in step S14, and by, for example, synthesizing the first page of all of the contents.

Thus, by the project activity support method based on this embodiment aspect, information is registered and viewed in units of project desktops, and security management is implemented by setting access rights based on user attributes for each project and for each set of contents. Thus, even when multiple projects are being run in parallel, information necessary to each project can be easily registered and viewed while controlling access rights with simple operations.

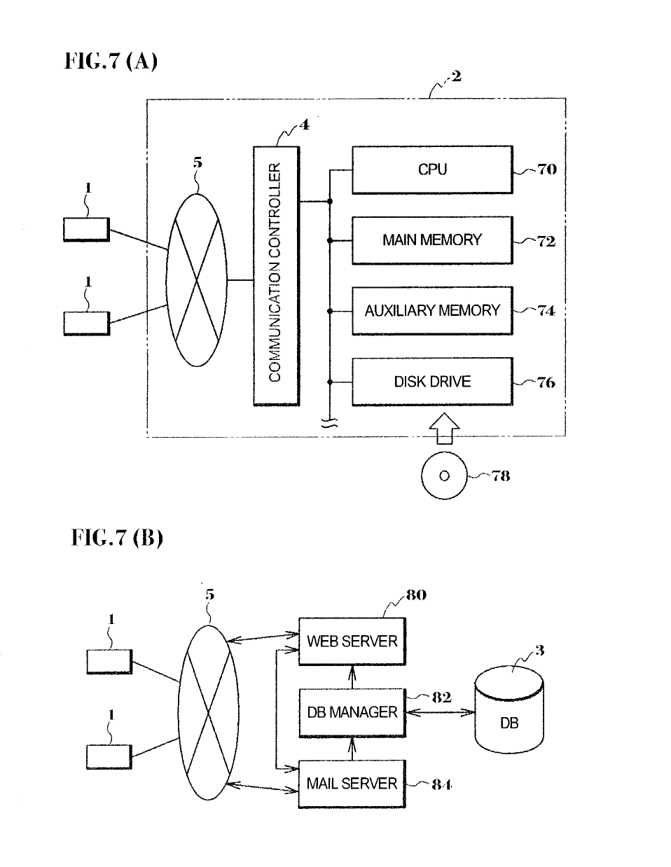

FIG. 7(A) is a block diagram of an example configuration of hardware resources in this embodiment aspect. As diagrammed in FIG. 7(A), the server 2 in the project management system according to this embodiment aspect comprises hardware resources that include a CPU 70 for performing arithmetic computations in accordance with a prescribed program, a main memory unit 72 for providing the CPU 70 with memory area, an auxiliary memory unit 74 such as a hard disk, and a disk drive 76 for reading data and programs from a memory medium 78 such as a CD-ROM, as well as a display device and input device and the like (not shown). In the auxiliary memory unit 74, contents content, and information relating to user attribute-oriented access rights set by project, are stored as the database 3.

The CPU indicated in FIG. 7(A) executes a project activity support program, and thereby the server 2 indicated in FIG. 7(A) functions as the project management system diagrammed in FIG. 1. The project activity support program is contained in the memory medium 78, and is transported to the disk drive 76 of the server 2. The CPU 70 controls the disk drive 76 and installs the project activity support program contained in the memory medium 78 in the auxiliary memory unit 74. Provision may also be made so that the project activity support program, in whole or in part, is downloaded from another server via the network 5. In addition to a compiled program, the project activity support program contains a script for driving the database and generating prescribed page data as well as image files and the like needed in producing the page data.

The project activity support program comprises the following instructions as instructions for causing the CPU 70 of the server 2 to operate. Specifically, a project-oriented contents registration instruction that causes contents contained in projects to be registered project by project, a project list generation instruction for causing a list of projects to be generated, when one or a plurality of sets of registered contents has been searched, or access has been made concerning members belonging to a project, which includes those contents or members, and a project desktop generation instruction for causing a page to be generated as a project desktop, when a project display request has been made by a user based on a project list generated by the server in response to such a project list generation instruction, that page being a page for displaying or accessing all of the contents included in that project. The CPU 70 implements the processing diagrammed in FIG. 5 by executing those instructions. Furthermore, by having the project desktop generation instruction comprise instructions corresponding to each process step indicated in FIG. 6, the CPU 70 will implement the processes indicated in FIG. 6. Furthermore, by having the project activity support program comprise instructions corresponding to the parts and functions indicated in FIG. 1, etc., the server 2 will operate as the project management system diagrammed in FIG. 1, etc.

When the language “instructions for causing the CPU to operate” is used here to operate the CPU 70 or server 2, one or both of two types of instructions are in view, namely instructions that by themselves cause the CPU 70 or the like to operate, and instructions that cause the CPU 70 to operate in dependence on a database management system (DBMS) or an operating system (OS) stored beforehand in the auxiliary memory unit 74, or the like. The “project-oriented contents registration instruction,” for example, in order to cause contents contained in projects to be registered by project, may be only an instruction for generating a registration page and passing that generated page to a program controlling communications with the user terminals 1. In that case, there will be cases where all of the programs required for registering contents by project are not contained in the memory medium 78, but only a program for generating registration pages is contained therein. These options are determined according to the relationships with the operating system in the server 2.

In the example diagrammed in FIG. 7, moreover, a single server 2 and a single CPU are provided, but one server may be provided comprising a plurality of CPUs, or provision may be made for dispersing the load over a plurality of servers. File management may be conducted at the server by making the access rights for contents data by project only a root (super user), causing the program to operate by root rights, and effecting actual contents-oriented security by edit button functions or the like. Also, if the database 3 is under the control of the server 2, then that database 3 may be created by other computers or in other disk units.

FIG. 7(B) is a block diagram of an example configuration of the server 2 when the internet is used as the network. This server 2 comprises a web server 80 that controls communications by http, a DB manager 82 that issues SQL text and the like to the database following a script input via the web server and returns search results as part of the page information to the web server 80, and a database (DB) 3. The server 2 may also comprise a mail server 84 that does such tasks as transmitting electronic mail to the user terminals 1 under the control of the web server 80 or the DB manager 82, automatically responding to received electronic mail, and registering the content written in received electronic mail to the DB 3. With the example that comprises the mail server 84, it is possible, when a predetermined change has occurred in a project desktop, for example, to perform such tasks as transmitting electronic mail to affected members, to effect registration to a bookshelf section with electronic mail including an attached file, to set electronic mail addresses for each project desktop, or to accept questions concerning a particular project from the outside, etc. Provision may also be made for adding web mail functions to make it possible to send and receive electronic mail to and from log-in users from within a web page. In that case, the web mail functions should be made accessible from personal desktops.

### EXAMPLES

Overall Configuration

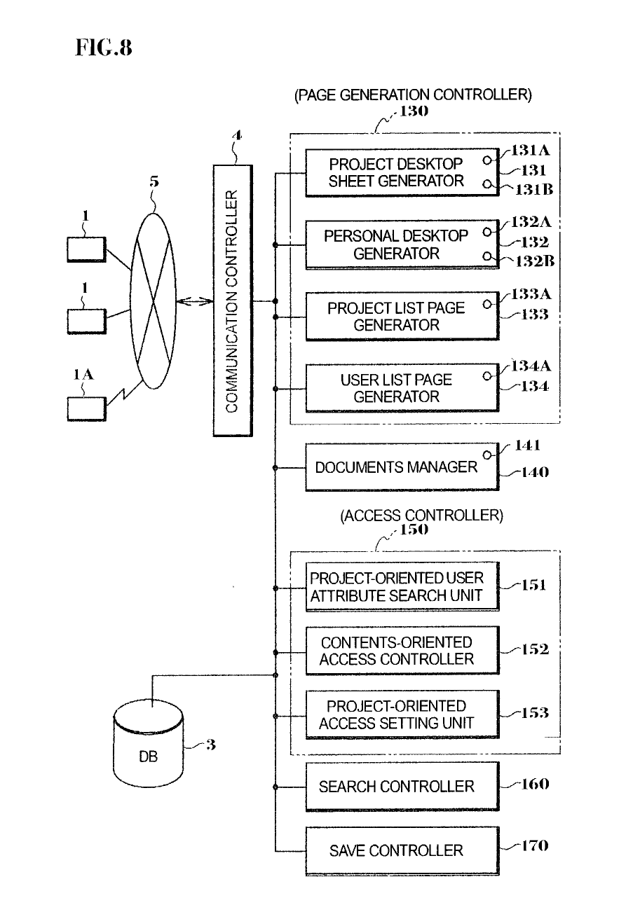

Examples of the present invention are described next. FIG. 8 is a block diagram of an example configuration of one example based on the present invention. In a preferred example, a page generation controller 130 for generating pages for project desktops and the like, a document management unit 140 for managing documents, an access controller 150 for managing access rights that accord with project-oriented and contents-oriented user attributes, a search controller 160 for controlling searches of project contents, and a save controller 170 for controlling the saving of project desktops are comprised.

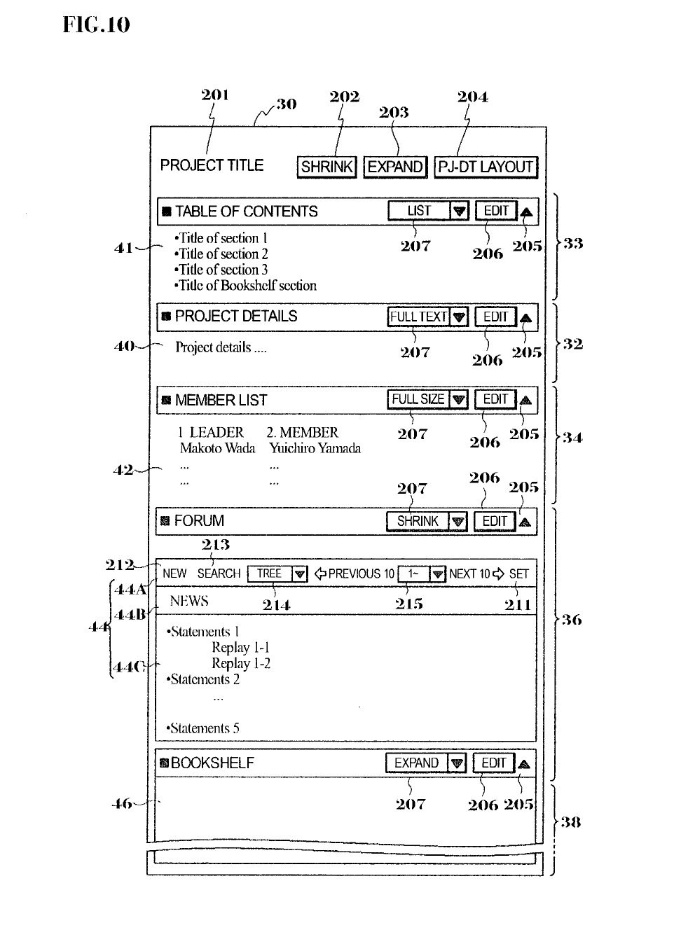

In this example, in particular, the server 2 comprises a communication controller 4 for transmitting prescribed pages to user terminals and receiving operation information for those pages, and a project desktop sheet generator 131 for reading contents data from the database 3 in response to the operation information received by the communication controller 4 and generating pages, as project desktops, project by project, for displaying or accessing all the contents belonging to those projects. This project desktop sheet generator 131 comprises functions for generating a project desktop 30 (cf. FIG. 10) that contains, as contents, a text section 32 for displaying text 40, a forum section 36 for recording and displaying user statements 44, and a bookshelf section 38 for managing files 46 transferred from users. In this example, because the forum section 36 and the bookshelf section 38 are provided in a project desktop that is a single page, information required for advancing a project can be managed integrally and easily, without having to switch software.

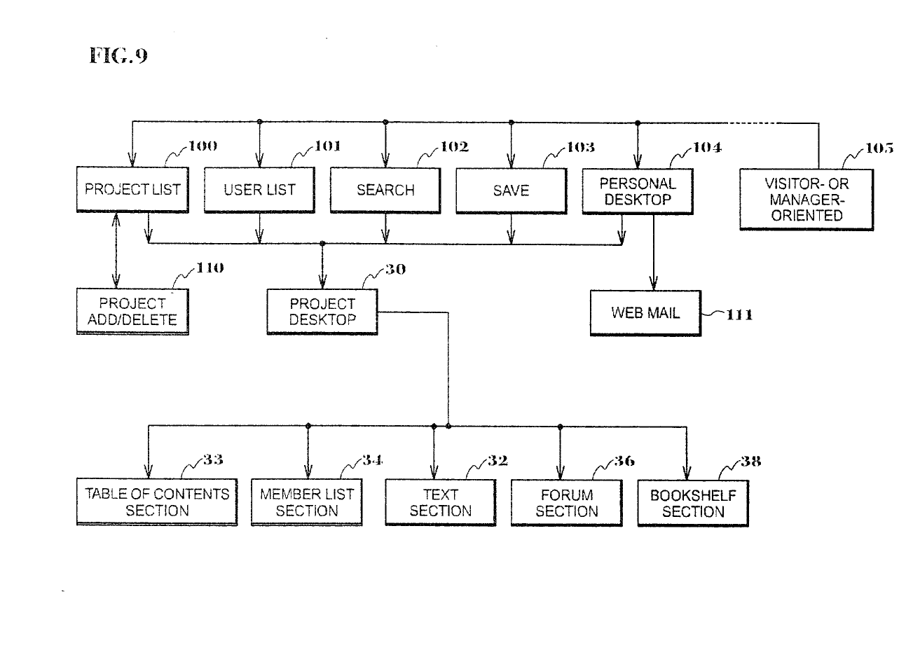

FIG. 9 is an explanatory diagram that represents a typical connection scheme for the various pages. Diagrammed here is the overall configuration (total package) in a preferred example. Advantages arising from relationships between the configuring elements are described individually. First of all, from the top page of the project management system, a user is able to access a project list page 100 for displaying a list of projects, a user list page 101 for displaying a list of users having log-in IDs, a search page 102 for searching project contents, a save page 103 for saving one or a plurality of project desktops, and a personal desktop page 104 that constitutes an individually oriented page for log-in users. These can also be accessed from a project desktop.

In the pages 100, 101, 102, 103, and 104 are provided links to project desktops. In the user list page, for example, the titles of projects to which the users belong can be incorporated as links. By making contents search results the project to which those contents belong, that becomes a link to the project desktop. Even when saves are implemented using the save page 103, project desktop titles are displayed for selecting projects. Provision may also be made so that, in the personal desktop page 104, a list of projects to which that individual belongs is displayed, and, when that project desktop is updated, the fact that that personal desktop page 104 was updated is displayed.

From the project list page 100, a project add/delete page 110 can be read out in order to add a new project or delete an existing project, etc. Provision may also be made so that, in the personal desktop page 104, a web mail page 111 can be called up for managing web mail. Various types of pages may also be provided that are oriented toward visitors having no log-in ID or systems managers or the like.

In the project desktop 30, as described earlier in terms of an embodiment aspect, a text section 32, forum section 36, and bookshelf section 38 are comprised. In addition, a table of contents section 33 that is a list of titles of contents in a project desktop, or a member list section 34 that is a list of members belonging to that project, may be provided. In this example, these contents sections are produced by project leaders and, when permitted by a leader, by members.

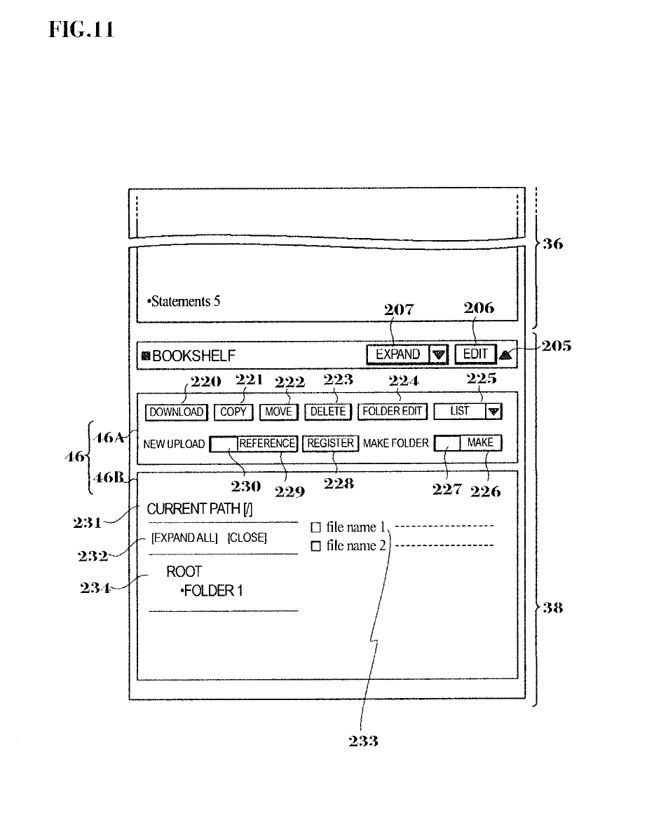

FIGS. 10 and 11 are explanatory diagrams that represent one example of a project desktop in this example. A summary description of the functions implemented in this example will now be given while referencing the graphical user interface diagrammed in FIGS. 10 and 11. The specific techniques for implementing these functions and the data structures and the like used in conjunction therewith will be described subsequently. The project desktop, to begin with, has a project title 201. In this example, there are three display stages available as contents section display formats, namely a full-size “full display (full size),” an “abbreviated display (name only)” that displays only the names of contents and not the contents themselves, and an “intermediate display (scroll)” that is intermediate therebetween, causes displays in a slightly smaller display area, and adds a scroll bar (not shown) to the contents section. The titles of the display modes will be different for different contents. For a text section, for example, these titles are made “full text,” “3 lines,” and “(omit) none,” while for a forum section the titles are made “large frame (expand),” “small frame (shrink),” and “(omit) none.”

For execution buttons, the project desktop has an expand button 202 for expanding the entirety of the several contents belonging to that project desktop, and an omit button 203 for causing a display, conversely, where content is omitted. The project desktop sheet generator 10 controls the drawing of the contents sections in response to operations of that expand button 202 and omit button 203. A desktop setting button 204 is an operation button for generating a page for setting a desktop. With that desktop setting page, such tasks as new contents generation are performed.

Each set of contents comprises a title therefor, a display format selection list 207 for selecting the display format, an edit button 206 for causing a page to display for editing the content and the like of that contents section, a link button 205 linked to the head of the project desktop, and the content of those contents. In the example diagrammed in FIG. 10, a table of contents section 41 displays the titles of each contents section according to a “one column list” designation. The title of the text section is “project content,” moreover, and a description of the content thereof is registered using text data. The registration, updating, and deletion of those text data are performed with a text data edit page that is displayed when the edit button is operated.

In the member list section 34, two leaders are registered, namely Makoto Wada, the first ranking leader, and Yuichiro Yamada, the second. The addition and deletion of members are performed with a member edit page that is displayed by that edit button. In this example, the member of the first rank is made the leader. A leader has the authority to determine access rights to each contents section. This ranking can be edited using a member list edit page that is called up by a member list section edit button.

In the forum section 36, the display format for the forum itself is implemented with a display format selection list indicated by the symbol 207, while the statement display format is implemented by a statement display format selection list 214 indicated by the symbol 214. Also provided are a new button 212 for causing a page to display for making a new statement, and a search button 213 for generating a page for searching statement content. For replying to a statement, provision may be made so that a reply button is deployed in a page for displaying statement content. A setting button 211 is also provided for activating a page for performing various settings pertaining to the forum section 36.

The forum contents 44 comprise a forum control area 44A wherein various operation buttons are deployed, a notice display area 44B for displaying text for communicating information relating to the forum to users, and a statement display area 44C for displaying the titles and content of statement content.

As diagrammed in FIG. 11, the bookshelf section 46 comprises a document management control area 46A, and a document file name display area 46B for displaying file names of document files actually registered in a virtual directory structure. This virtual directory structure-in which the project desktop is made the root directory, within a plurality of folders is defined hierarchically-is for managing document files according to document type and so forth. The display formats in the document file name display area 46B follow the selection made with a display format selection list 225. The size of the display in the bookshelf section is implemented using the display format selection list 225 indicated in FIG. 11 by the symbol 207.

In terms of operation buttons for document files, a download button 220 for downloading a document file registered in the bookshelf section 46 to a user terminal 1, a copy button 221 and a move button 222 for copying a document file in the bookshelf section 38 or in another project desktop, or moving a document file, and a delete button 223 for deleting a registered document file are provided. A make button 226 for making a virtual directory (folder) inside the bookshelf section and a folder edit button 224 for editing the name of that folder, etc., are provided.

In order to register a document stored in a user terminal 1 in the bookshelf section 38 of the server 2, it is necessary to select the document file to be registered and to perform a registration operation. In the example diagrammed in FIG. 11, a reference button 229 displays, on that user terminal 1, a selection screen for document files in that user terminal 1, in accordance with the operating system of that user terminal 1. When the user selects the document file to be registered from that selection screen, the storage position for that selected file is input to a field 230. Subsequently, when a register button 228 is operated, the server receives the selected file.

In the document file name display area 46B, first, the folder hierarchy in the current display is displayed as the current path 231. A button 232 for performing such tasks as expanding all the folders contained in the current folder or closing an expanded folder, a folder display area for displaying folders contained in the current folder, and a file name display area 233 for displaying the document file names and folder names of document files contained in the current folder are provided.

By using the project desktop diagrammed in FIG. 10, it is possible to easily share document files needed in projects, and to easily share necessary information such as statements made in forums, generally, from project initiation and through development. Also, because this project desktop is produced for each project, even in cases where multiple projects are being advanced simultaneously, there will no longer be electronic loss of information necessary to each project, nor will long times be needed for searches.

Access Control According to User Attribute

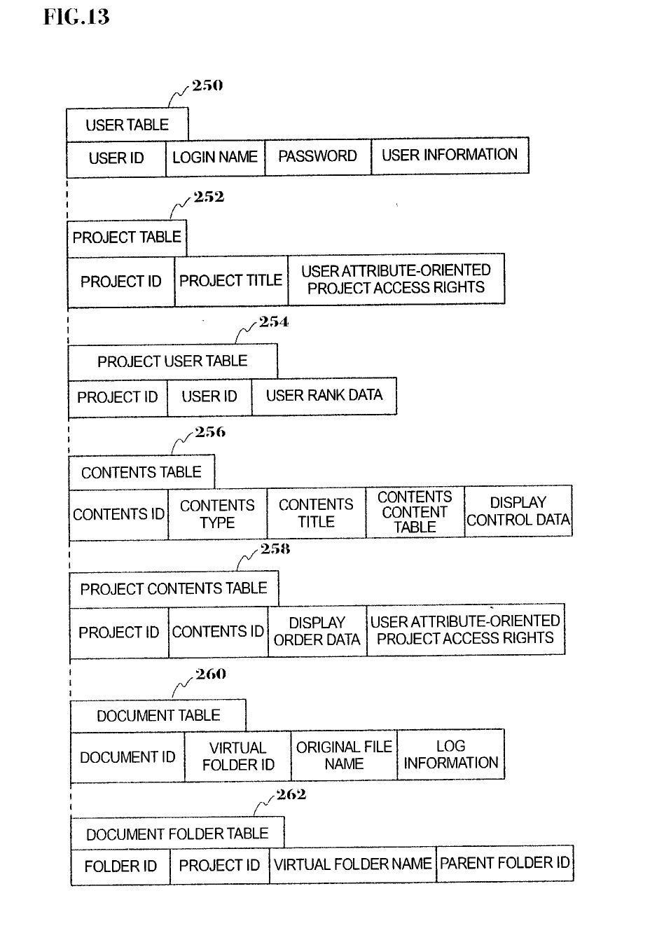

Next are described examples of controlling access to project desktops in their entirety or to the various contents therein, according to user attributes determined by project for leaders, members, non-member log-in users, and visitors having no log-in ID. In this example, the database 3 comprises a project user table 254 wherein are stored, for each project, the attributes, for projects, of the leaders and members, etc., of those projects, established by project, and a project contents table 258 containing user attribute-oriented access rights for each set of contents belonging to those projects (cf. FIG. 13).

As diagrammed in FIG. 8, moreover, the access controller 150 in the server 2 comprises a project-oriented user attribute search unit 151 for determining, for a user currently communicating (in session) via the communication controller 4, the attribute that relates to the project which is the subject of that communication, using the project user table 254, and a contents-oriented access controller 152 for controlling displays and operation content for each set of contents in a project desktop based on the attribute for a product of an accessing user determined by the project-oriented user attribute search unit 151 and on the user attribute-oriented access rights recorded in the project contents table 258.

The project-oriented user attribute search unit 151, using the project user table 254, determines the user attribute for that project. And the contents-oriented access controller 152, using the project contents table 258, determines the user attribute-oriented access rights for those contents.

In this example, the leader who is the author of a project desktop is prompted to determine the access rights to contents for that project desktop. For that reason, it will be well to make the member list a mandatory configuration in the project desktop. By displaying the member list, it becomes easier for a leader to give consideration to what he or she should in setting access rights for members and nonmembers. The project desktop sheet generator 130 comprises functions for generating the member list section 34 for displaying and adding member lists to each project desktop based on lists of members belonging to projects contained in the project user table 254.

In general, it will be a leader who adds a contents section to a project desktop. And, when producing a contents section, a prompt is made to specify the access rights for that newly produced contents section. The initially set (default) access rights may be displayed, for example, so that a selection thereof can be made.

In order to limit the access rights to an entire project desktop, moreover, the database 3 may be provided with a project table 252 wherein are recorded user attribute-oriented access rights to the entire project desktop, and the server may be provided with a project-oriented access setting unit 153 for setting access rights to that project desktop based on user attributes determined by the project-oriented user attribute detector.

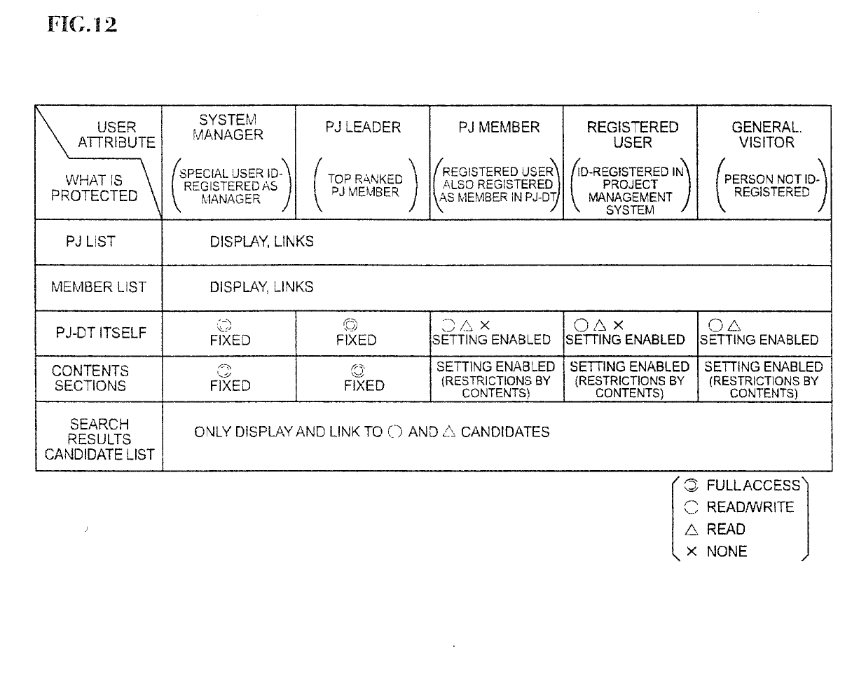

FIG. 12 is an explanatory diagram showing the relationship between attribute-oriented access rights and user attributes for a project in an example wherein an internal network in a company or university or the like is used. In this example, users are classified into system managers, project (PJ) leaders, PJ members, registered users (i.e. users having log-in IDs), and general visitors having no log-in ID. Project desktop lists and member lists can be displayed to all users. For an entire project desktop, the system manager and the PJ leader are fixed at the modification enabled (full access) ( ) security level. The PJ leader and system manager can set the project desktop access rights for PJ members. There are three settings possible, namely updating enabled (write) ( ), display enabled (read) (Δ), and display disabled (none) (x). In the example diagrammed in FIG. 12, general visitors are mandatorily disabled from updating.

The system manager and PJ leader can also modify access rights settings for contents, being able to make settings by user attribute according to the contents section, such as disabling such operations as downloading and copying in the bookshelf section. As diagrammed in FIG. 12, in this example, no access rights are determined for any particular user having a personal log-in ID. Access rights are determined solely according to the roles played by users in a project. Thus a PJ leader is able to perform adequate access management without performing onerous setting work. Furthermore, there is no need to reset the access rights even when log-in users are added or deleted, or members are added to or removed from a project, etc.

FIG. 13 is an explanatory diagram of one example of a data structure used in the configuration diagrammed in FIG. 8. The data structure diagrammed in FIG. 13 represents project activity support data used in the project management system diagrammed in FIG. 8. These data are stored in a hard disk, for example, and constitute a database. The project activity support data comprise such user information as user IDs, log-in user names, log-in passwords, and user contact information for a plurality of users, together with a user table 250 wherein those pieces of information are respectively stored. The project activity support data comprise a project table 252 wherein are stored project IDs for identifying a plurality of projects, a project title for each of those project IDs, and user attribute-oriented access rights for those projects, and also a project user table 254 wherein are stored the user IDs of users belonging to the projects, and the order of the users which constitutes user attributes.

The project activity support data also comprise the contents table 256 wherein are recorded the types of contents of the forum section or bookshelf section or the like which are generated for each project, and the project contents table 258 wherein are recorded the contents IDs of contents belonging to the projects, user attribute-oriented access rights to the several contents, and the display order of the several contents (contents order data). The several contents display order is the order in which contents are displayed in the project desktop, such as whether the bookshelf section is to be above the forum section or vice versa, for example.

Also, in this example, the project user table 254 is used, when a project desktop is generated by the server 2, for determining the user attributes of the user who has made a request to display that project desktop. The product contents table, moreover, is used in determining the contents display mode according to user attribute-oriented access rights, and is also used for specifying the display order for the various contents.

In an example where the project contents table 258 has contents order data that record the display order in the project desktop of contents belonging to that project, as diagrammed in FIG. 8, the project desktop sheet generator 131 may comprise a contents section drawing function 131A that reads out text and other contents based on the contents order data and sequentially draws contents sections in accordance with access rights set by the contents-oriented access controller 152, and a synthesis control function 131B for synthesizing and controlling the contents sections drawn by the contents section drawing function 131A, in the order of the contents order data, as a single-page project desktop.

The contents section drawing function controls access by making settings to enable or disable the use of contents section edit buttons and the like in accordance with the access rights, and also draws the content of contents as portions of a page, in the display format set with the display format selection list 207 or the like. The synthesis control function 131B produces a single-page project desktop by synthesizing contents sections in the order designated in the contents order data. Provision may also be made so that the synthesis control function 131B, after contents synthesis is complete, transmits that project desktop to user terminals. Or provision may be made so that the synthesis control function 131B sequentially generates contents sections in an order following the contents order data, and transmits contents sections piecemeal, after the generation thereof is complete, to the user terminals 1. These contents order data can be modified or updated with a desktop setting page that is displayed by the operation of the desktop setting button 204. In general, such updating is performed by the leader. When the leader is allowed to write member access rights to the project desktop, members can also edit those contents order data. These contents order data are constituted as one set for each project ID. However, with respect to the contents in one project desktop, provision may be made so that, in cases where what various members are interested in differs, the contents order data are defined for each member.

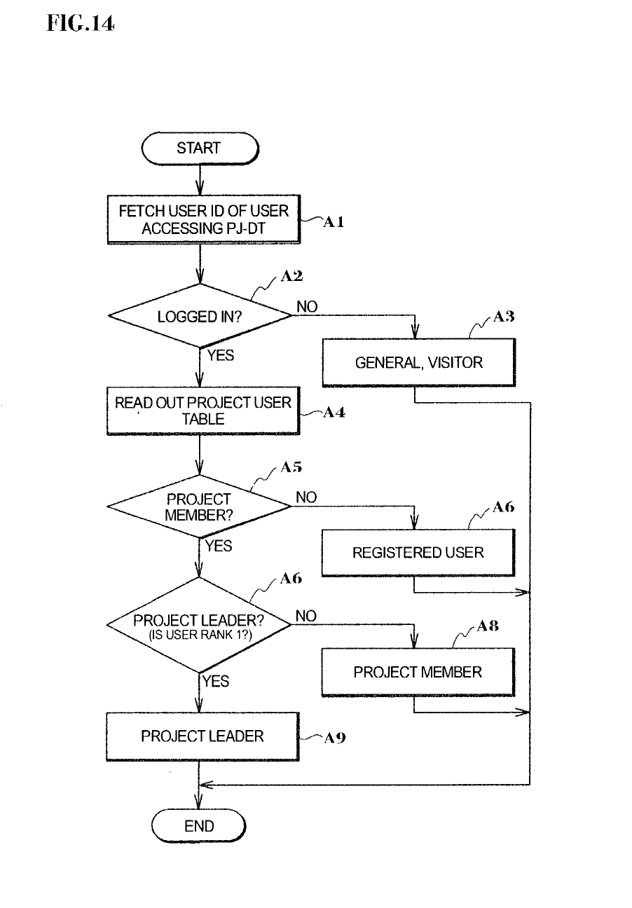

FIG. 14 is a flowchart representing one example of a user attribute determination processing routine in the configuration diagrammed in FIG. 8. The processing steps diagrammed in FIG. 14 constitute the detailed operations of the project-oriented user attribute search unit 151 indicated in FIG. 8.

In the example diagrammed in FIG. 14, first, the user ID of a user in a session making access to a project desktop (PJ-DT) is fetched from the system (step A1). Following that, a determination is made as to whether or not this user is logged in (step A2), and, if not logged in, that user is determined to be a general visitor as diagrammed in FIG. 12 (step A3). If that user is logged in, on the other hand, then the project user table 254 is read out on the basis of the project ID of the project being accessed (step A4), and a determination is made as to whether or not that log-in user is a member of that project (step A5). If not a project member, he or she is determined to be a registered user as diagrammed in FIG. 12 (step A6).

If that user is a project member, on the other hand, user order data are read out from the project user table, and a determination is made as to whether or not that user is the leader of that project by determining whether or not the rank data for that user are 1 (step A7). If not the project leader, the log-in user in that session is determined to be a project member (step A8). If the rank data are 1, then that user is determined to be the leader (step A9). By this flowchart diagrammed in FIG. 14, the user attributes of users accessing a project desktop are determined uniformly.

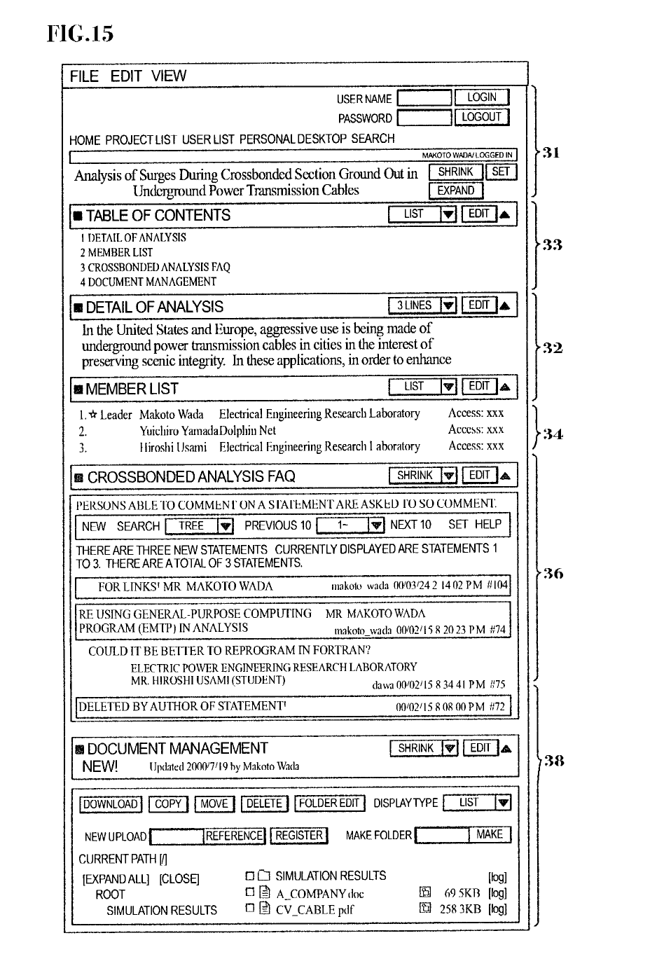

FIG. 15 is an explanatory diagram of a specific example of a project desktop display in this example. In the example diagrammed in FIG. 15, the project desktop is displayed with a browser for displaying HTML pages. In the upper portion of the project desktop are fields for entering the user name and password, and that is where log-in and log-out operations are performed.

“Home” is a link to the home page of the project management system. “Project list” is a link to the project list page 100 diagrammed in FIG. 9. Similarly, “user list,” “personal desktop,” and “search” are, respectively, links to the user list page 101, the personal desktop page 104, and the search page 102. In the example diagrammed in FIG. 15, research being done on a certain subject in a research laboratory in a university constitutes the project.

In the example diagrammed in FIG. 15, in the text section 32 that provides a summary of the project, a summary of the content of the research is written by the leader. The members are made up of a researcher (in an electrical engineering research laboratory) who serves as the leader, an overseeing instructor, personnel working in the same research laboratory, researchers with a cooperating company (Dolphin Net), and testing assistants and the like. In the forum, which has been named the Question Box by the leader, such things as which programming language to use are discussed. The examples of document files registered for this project include a case of adoption at Company A and a document relating to reducing the weight of CV cables.

In the example diagrammed in FIG. 15, the research content is shown as text only, but provision may also be made for pasting images or imbedding links to a document file.

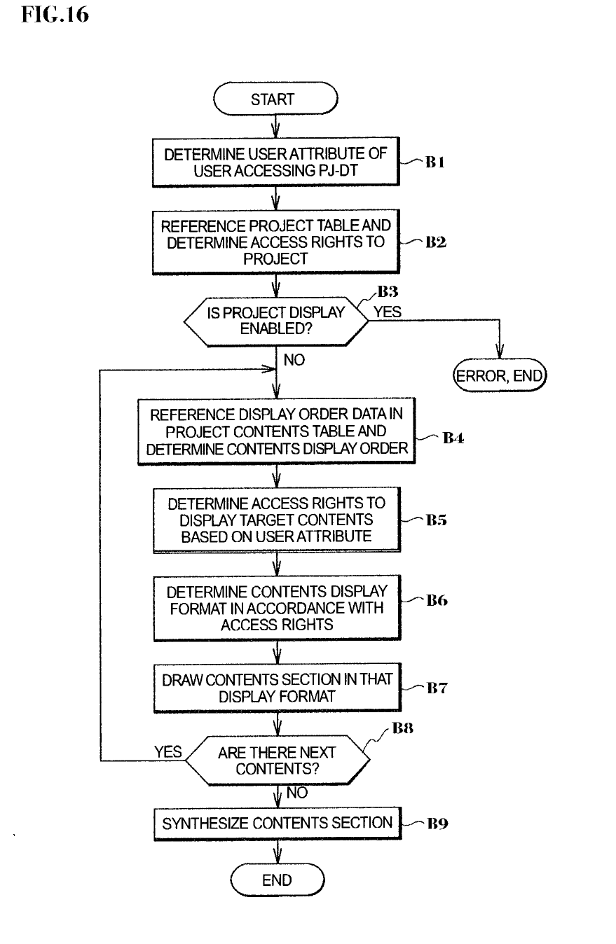

FIG. 16 is a flowchart representing one example of a processing routine for displaying the project desktop (PJ-DT) diagrammed in FIG. 15, etc., with the configuration diagrammed in FIG. 8. In the example diagrammed in FIG. 16, first, the user attribute of the user accessing the project desktop is determined according to the processing routine diagrammed in FIG. 14 (step B1). Following that, the project table 252 is referenced, and the access rights to the project for that user attribute are determined (step B2). If the setting is such that project display is disabled, the user terminal is notified of an unable-to-display error and processing is terminated.

If, on the other hand, project display is enabled, then a determination is made as to whether or not the display and updating (writing to) of the various contents are enabled. First, the contents display order data in the project contents table 256, and the type of contents to be displayed and the contents display order are specified (step B4). Following that, the project contents table 258 is referenced, and the access rights to the contents to be displayed are determined based on the user attribute (step B5). Then the contents display format is set according to the access rights (step B6). Whether or not an operation button can be used is controlled, for example. Following that, the content of the contents is read out from the DB 3, according to the display format determined by various settings, and the contents section is drawn as part of the page (step B7). The process for drawing this contents section will be different for different contents, wherefore the configuration may be made such that separate program routines are called up for each.

When the drawing of the contents is complete, the contents display order data are referenced, a determination is made as to whether or not there are next contents (step B8), and, if there are next contents, the processing is repeated from step B4. If there are no longer any next contents, on the other hand, the contents sections are synthesized in the order of production (step B9).

New Project and Contents Production

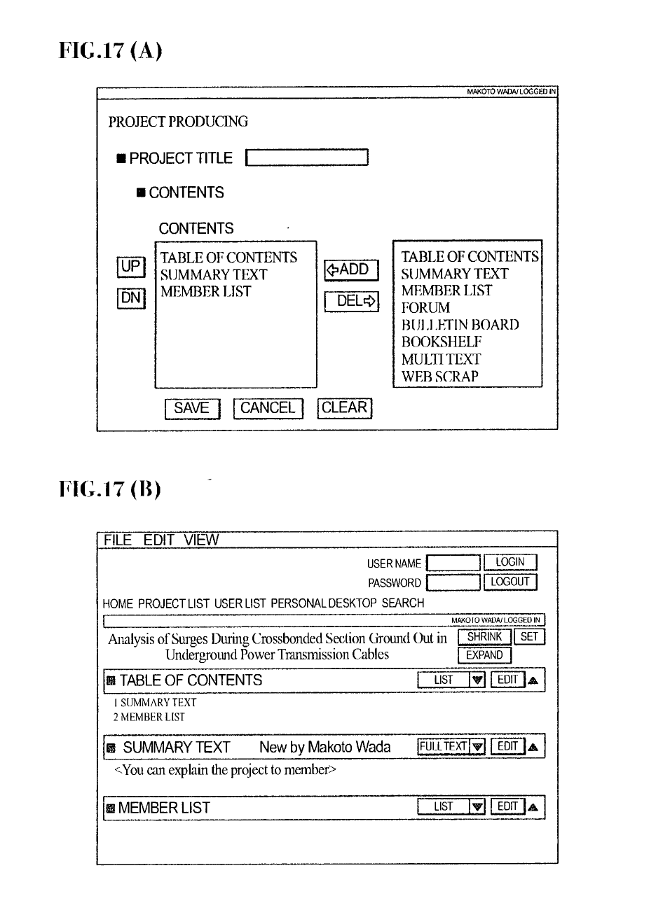

FIG. 17 is an explanatory diagram of one example of a page for producing a project desktop with this example. FIG. 17(A) represents an example of a project production page, and FIG. 17(B) an example of an initial screen in a project desktop with this example. As diagrammed in FIG. 17(A), when a new project is to be produced, the user is prompted to enter a project title, furigana (Japanese phonetic characters) to facilitate various sorts for Japanese Language, and designations of contents to be included in the project desktop. In this example, among the contents, the table of contents, summary text, and member list are made contents that are contained in the project desktop at the time of initial establishment. When the save button is operated in the condition diagrammed in FIG. 17(A), the project desktop diagrammed in FIG. 17(B) is generated. That which is written in the table of contents section is automatically generated. In the example diagrammed in FIG. 17, no entries are made in the summary text section.

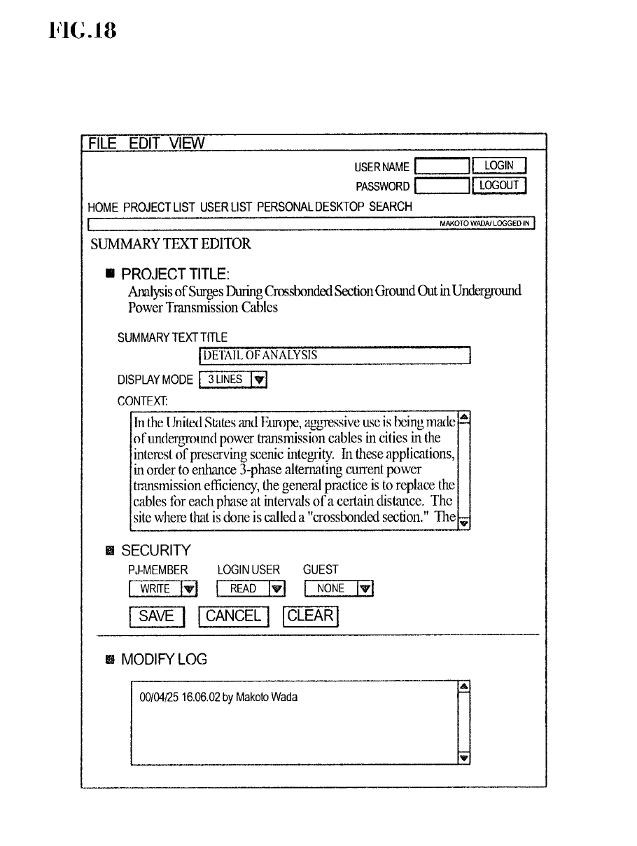

FIG. 18 is an explanatory diagram of one example of a text editing page for adding text data (text section) to the project desktop, or updating those text data, in this example. This text editing page is displayed when the edit button in the text section 32 has been operated. Accordingly, the operation of the edit button in this text section is disabled for users who cannot update text. In the example diagrammed in FIG. 18, the user is prompted to enter a summary text title, a text section display mode, and content. When the user in the session is a leader, security designations are accepted, as diagrammed in FIG. 18. Provision may also be made for displaying a record (log) of modifications made in these text contents to date. When the save button is operated in the condition diagrammed in FIG. 18, updating to the text section 32 indicated by the symbol 32 in FIG. 15 is effected.

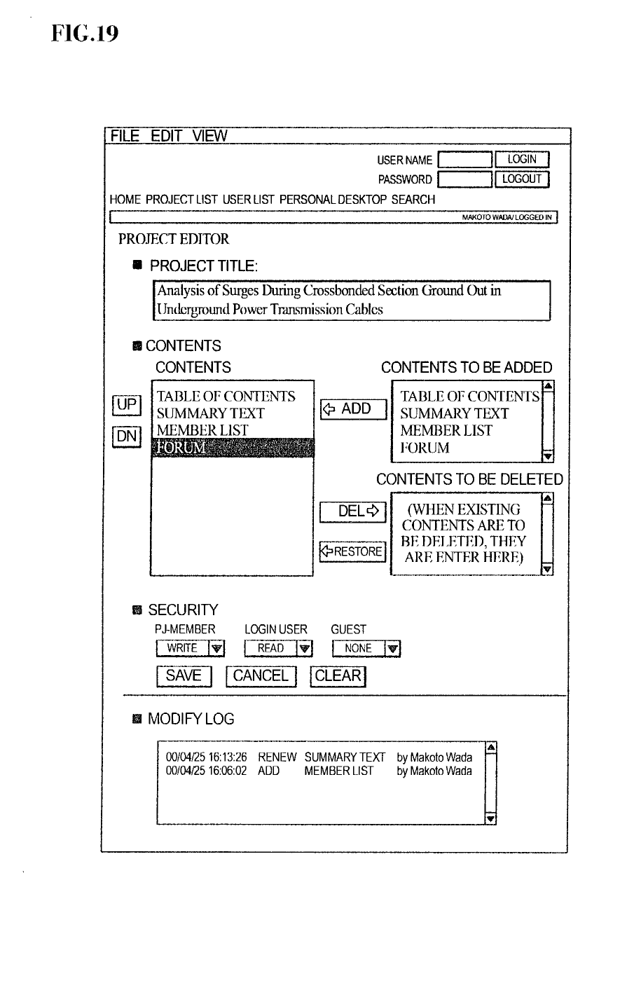

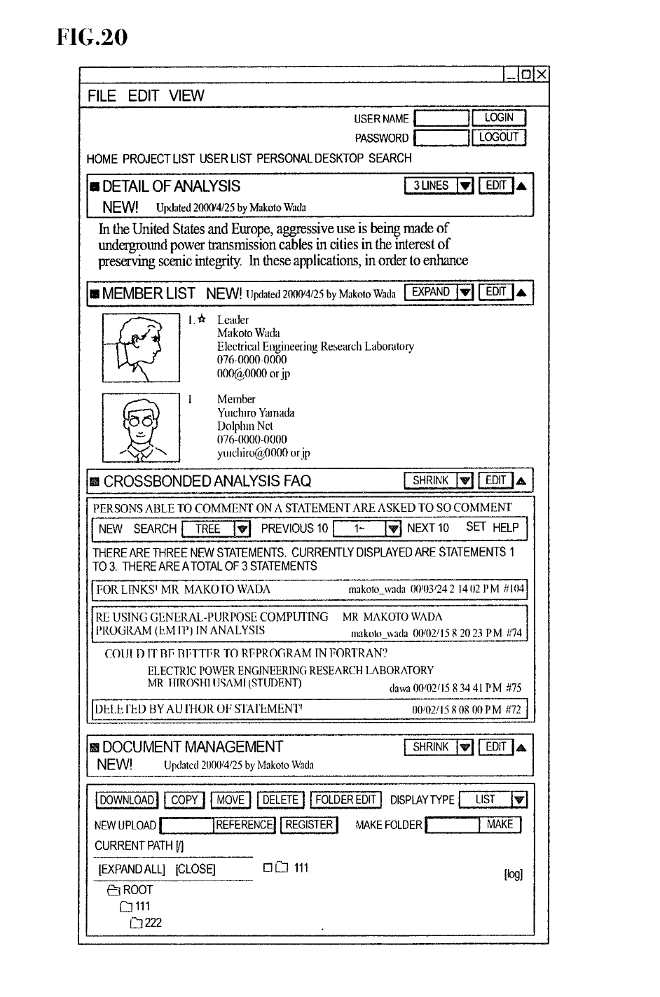

FIG. 19 is an explanatory diagram of one example of a project editing page. This project editing page is displayed by operating the desktop edit button indicated in FIG. 15. When editing the project desktop, it is possible to modify the project title and to add or delete contents. As in the case diagrammed in FIG. 18, the leader will be prompted to make user attribute-oriented security settings. FIG. 20 is an explanatory diagram representing an example where a bookshelf section is added to the project desktop in this example. As diagrammed in FIG. 20, etc., because the project desktop will grow as the project progresses, a professor in a research laboratory can ascertain how each research project is progressing by viewing each of the project desktops, for example, and can provide guidance appropriate to each situation. In an example where the user terminals 1 are connected via the internet, moreover, a project being jointly carried on in Tokyo and California can be managed with a single desk top, which can be viewed in turn by a professor participating in a conference in London. Hence project management that conventionally has been very difficult can be effected easily thanks to such management by project desktop and definite access management by user attribute.

Searches

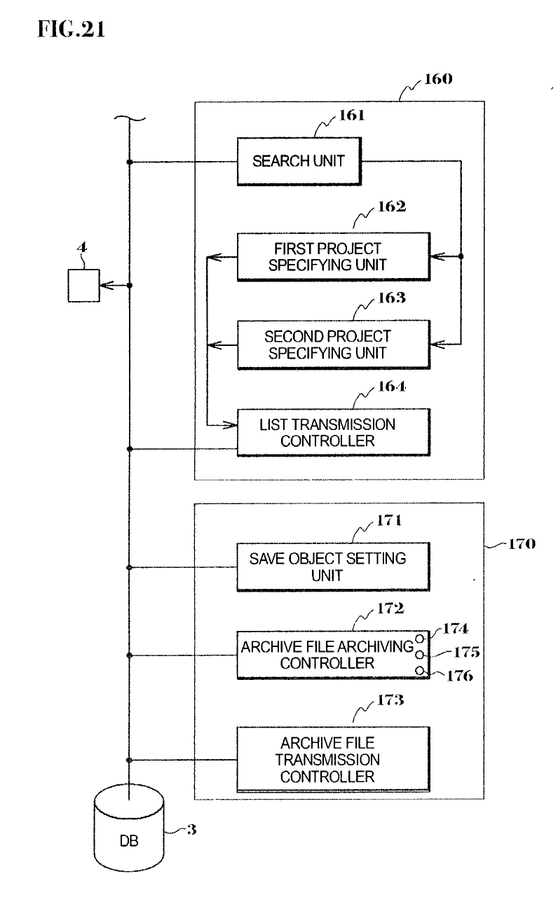

Next, searches of contents and the like are described. In FIG. 21 is diagrammed an example of the detailed configuration of the search controller 160 indicated in FIG. 8. Referring once again to FIG. 13, the database 3 comprises the project user table 254 wherein are stored lists of the projects and of the contents included in those projects, a document table 260 wherein are stored the locations where document files transmitted via the bookshelf section 38 of the project desktop are stored, etc., and a document folder table 262 wherein are stored virtual deployment positions in the bookshelf section 38 for the document files managed by the document table 260. The actual document files are converted to special file names for management purposes and stored in a hard disk or the like managed by the server 2.

Also, as diagrammed in FIG. 21, the search controller 160 of the server 2 comprises a search unit 161 for implementing searches, in response to operations at the user terminals 1, across the various projects, of the contents in those projects and of document files managed by the document table, and specifying contents titles or document titles as search results, a first project specifying unit 162 that references the project contents table 258 using the contents titles searched out by the search unit 161, and specifies the projects to which those contents belong, a second project specifying unit 163 that references the document table 260 and the document folder table 262 using the document titles searched out by the search unit 161, and specifies the projects to which those documents belong, and a list transmission controller 164 for transmitting a list of projects specified by the first and second project specifying units 162 and 163 to user terminals, as the search results of the search unit, in a condition of being linked to the project desktop.

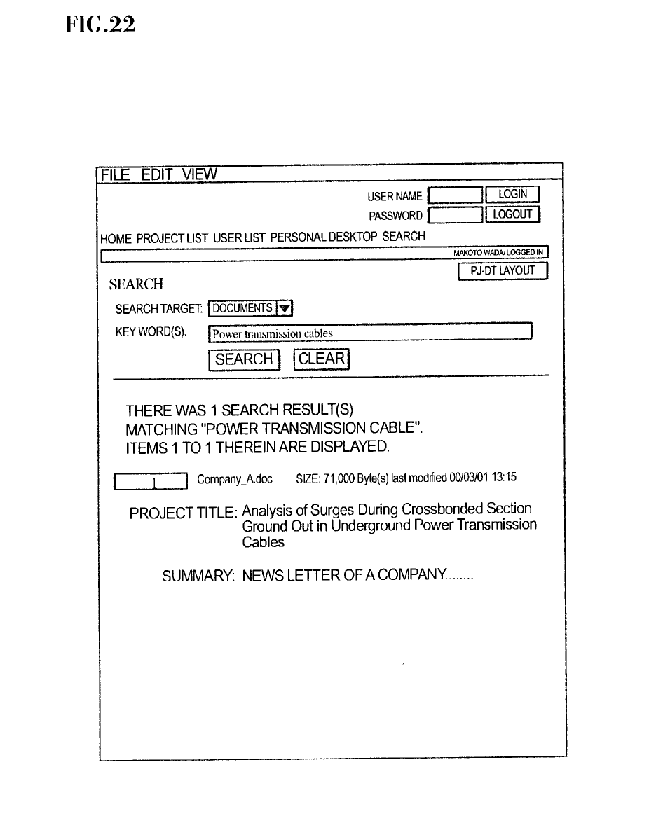

FIG. 22 is an explanatory diagram of one example of a search results page generated by the list transmission controller 164. As diagrammed in FIG. 22, in this example, the search unit 161 prompts the user to specify a search target. As shown here, document contents (full text search of document files registered in bookshelf section 38) are selected. “Power transmission cables” was entered as a key phrase and the search was executed. Let it be assumed that, as search results, there was a hit on “Company_A.doc” diagrammed in FIG. 15. The second project specifying unit 163 first references the document table 260 and specifies the ID of a virtual folder to which that document belongs. The second project specifying unit 163 then references the document folder table 262 and specifies a project ID from the virtual folder ID. Thereupon, from the project table, the project title “Analysis of Surges During Crossbonded Section Ground Out in Underground Power Transmission Cables” can be specified.

In the example diagrammed in FIG. 22, a single document file has been searched out, wherefore there is only one project involved. The list transmission controller 164 transmits this project title to the user terminal as the search results of the search unit 161 in a condition of being linked to the project desktop. In the search results page, the project name is an operation button, and a project desktop like that diagrammed in FIG. 15 will be displayed when that project name (the link, for example) is operated.

For searching document files, it will be well to generate an index for document files ahead of time, during a time frame of low server load, and then search document files based on that index. It will also be well to make provision so that synopses of a certain length are automatically generated from document files and included in the search results.

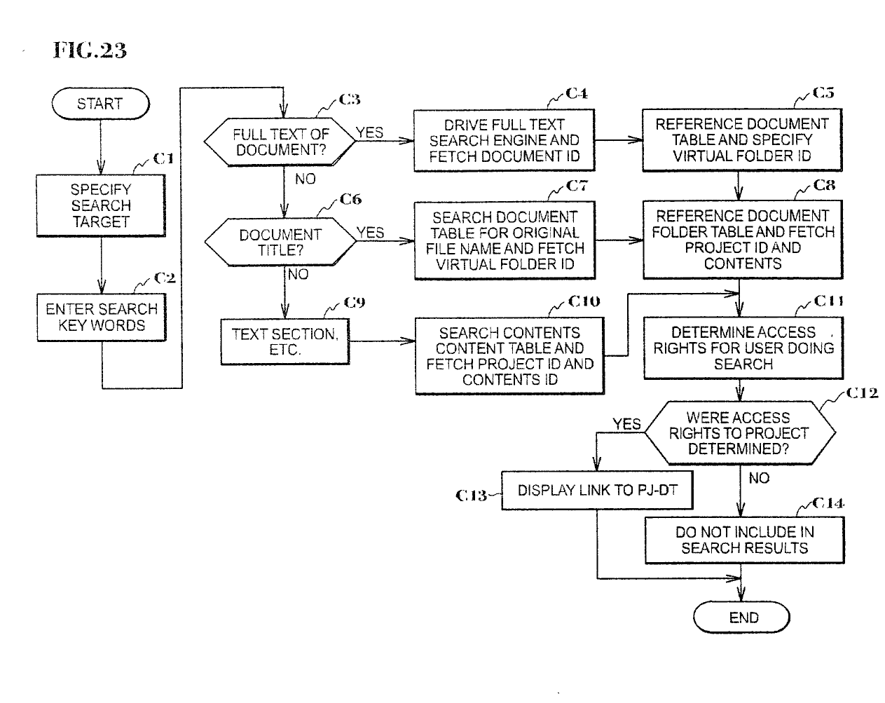

FIG. 23 is a flowchart showing one example of a search processing routine according to this example. The processing routine diagrammed in FIG. 23 represents an example of the detailed operation of the search controller 160. First, the search target is specified (step C1). Following thereupon, the user is prompted to enter key words for the search (step C2). If this is a full text search of document content (step C3), a full text search engine is driven and a document ID is fetched (step C4). Following that, the document table 260 is referenced, and the ID of a virtual folder to which that document belongs is specified (step C5). Then the document folder table 262 is referenced, and a project ID and contents ID are fetched (step C8). The processing routines in these steps C4, C5, and C8 constitute a first operation example for the second project specifying unit 163 indicated in FIG. 21.

When the search target is a document title (file name of a document file) (step C6), the original file name is searched in the document table, and a virtual folder ID is specified (step C7). Following that, the document folder table is referenced, and the project ID and contents ID are fetched (step C8). The processing routines in these steps C6, C7, and C8 constitute a second operation example for the second project specifying unit 163 indicated in FIG. 21.

If the search target is a text section or a member list or the like (step C9), a contents content table (such as a text table (not shown), for example) is searched, and a project ID and contents ID are fetched (step C10). The processing routines in these steps C9 and C10 constitute an operation example for the first project specifying unit 162 indicated in FIG. 21.

When a project is specified, the user attribute of the user making the search is determined (step C11). This step C11 determines the user attribute of the user making the search by the user attribute determination processing routine diagrammed in FIG. 14, for example. This user attribute determination is done for each project specified. When access rights to a project exist, a link to the project desktop (PJ-DT) is displayed (step C13). If there are no access rights to the project, on the other hand, the link to that project is not included in the search results (step C14). This processing routine is executed for all projects specified.

In this manner, a project to which the content of contents searched belongs is specified, and a link to the project desktop of that project is provided as search results, wherefore it becomes easier to access peripheral information, and grasp the background against which and purpose for which those searched contents were produced, etc. Even if a search is conducted when one's memory is vague, a user can be guided unconsciously to the search results aimed at. Furthermore, in cases where a user wishes to reutilize resource materials used in a past project, searches are possible by a variety of approaches, such as with keywords used in a document file, or a text in which a project summary was included, etc., wherefore it is easy to retrieve the original resource materials.

Saves

A description is given next of the relationship between saving project desktops and bookshelf sections. In an embodiment aspect described earlier, in a case where the data structure diagrammed in FIG. 13 was used, the server 2, as diagrammed in FIG. 1, includes the document management unit 140 that accommodates document files transmitted via the bookshelf section 38 in a document table 260, and also deploys those document files in a virtual directory in the bookshelf section 38. This document management unit 140, moreover, comprises a document operation control function 141 for copying and deleting document files in accordance with user attribute-oriented access rights set by the contents-oriented access controller 152 and for submitting those document files for downloading to a user terminal.

With this example, document files managed by this document management unit 140 can be saved in a single batch by the save controller 170 indicated in FIG. 8. With this example, as diagrammed in FIG. 21, the save controller 170 comprises a save target setting unit 171 for setting one or a plurality of projects as save targets, an archive file archiving controller 172 for archiving the contents contained in the one or the plurality of project desktops set by the save target setting unit 171, in one archive file, and an archive file transmission controller 173 for transmitting the archive files archived by the archive file archiving controller 172, in response to an operation at a user terminal, to that user terminal.

The archive file archiving controller 172, in turn, comprises a project desktop page generator 174 for generating project desktop pages wherein contents content displays or links to portions of contents are written with a markup language, for each project, in accordance with access rights set by the contents-oriented access controller 152, a file storage function 175 for storing image data used in that project desktop page and document files held in the document table in a associated folder, and an archive compression function 176 for storing a project desktop page and the content of a associated folder in one archive.

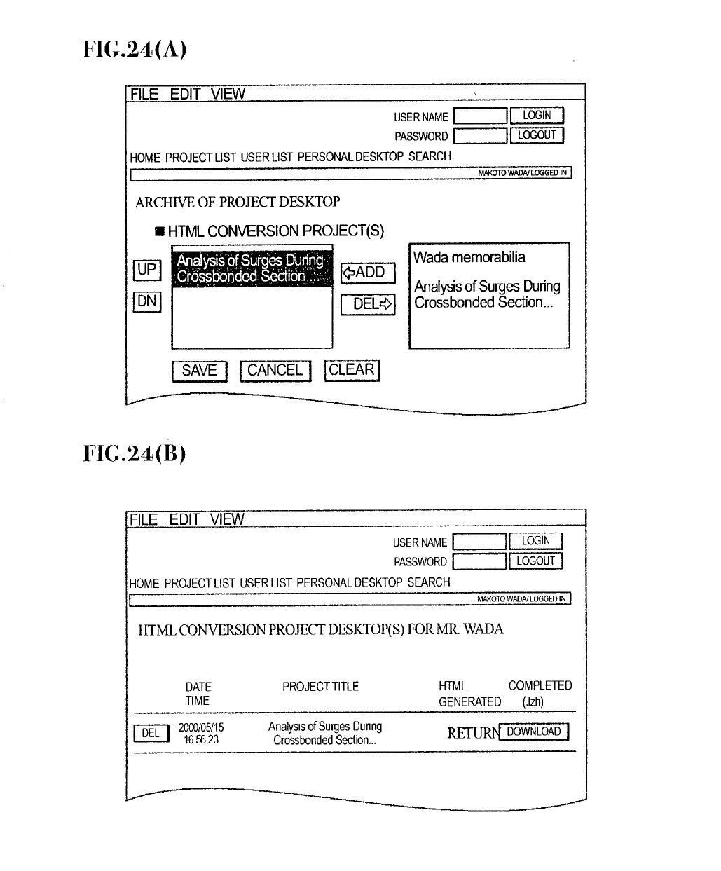

FIG. 24(A) is a diagram of an example of a page for selecting a project as a save target. The save target setting unit 171, as diagrammed in FIG. 24(A), generates a project desktop selection page, and prompts the user doing the save to select the project desktop that is to be the save target. At that time, it will be well to display only projects that are display enabled according to the user attribute of the user in the session doing the save.

With the archive file archiving controller 172, all data necessary to the project desktop display are extracted from the database and made an archive file. In a preferred example, moreover, that archive file will be compressed. More specifically, the project desktop page generator 174 generates a project desktop page wherein the display of the content of contents made display enabled or a link to a contents portion is written with a markup language (ML) such as HTML or XML. Although this project desktop page does not greatly differ in appearance from the project desktop diagrammed in FIG. 15, nevertheless, in the first place, link information to document files or forum statement content and the like linked to from that project desktop is rewritten. In the second place, it will be well to delete the edit button and the like in order to disable such editing as adding content and the like.

The file storage function 175 stores image data used in this project desktop page and document files accommodated in the document table in an associated folder. In an example where portrait photograph images of the members are displayed in the member list, for example, those portrait photograph images are read out from the user table and stored in an associated folder. In the case of a forum or the like where a tree-form display is made, the content of each statement will become an individual ML page, wherefore an ML page wherein the content of those statements is written is also stored in an associated folder. Document files registered in a bookshelf section are also stored in an associated folder. The project desktop page generator 174 updates links from the project desktop to document files, statement content, and portrait photograph image files and the like using an associated folder name or the like.

The archive compression function 176 archives project desktop pages and associated folder content in a single archive and compresses them. In that way, all of the content in a project desktop is archived and compressed in a single file. By implementing compression, the communication time required when transmitting that archive file to a user terminal 1 can be shortened. The archive file transmission controller 173 generates a page for downloading an archive file (a project desktop rendered in HTML, for example) such as diagrammed in FIG. 24(B), for example. Provision may also be made so that the archive file transmission controller 173 adds that archive file to the bookshelf section 38 in the project desktop.

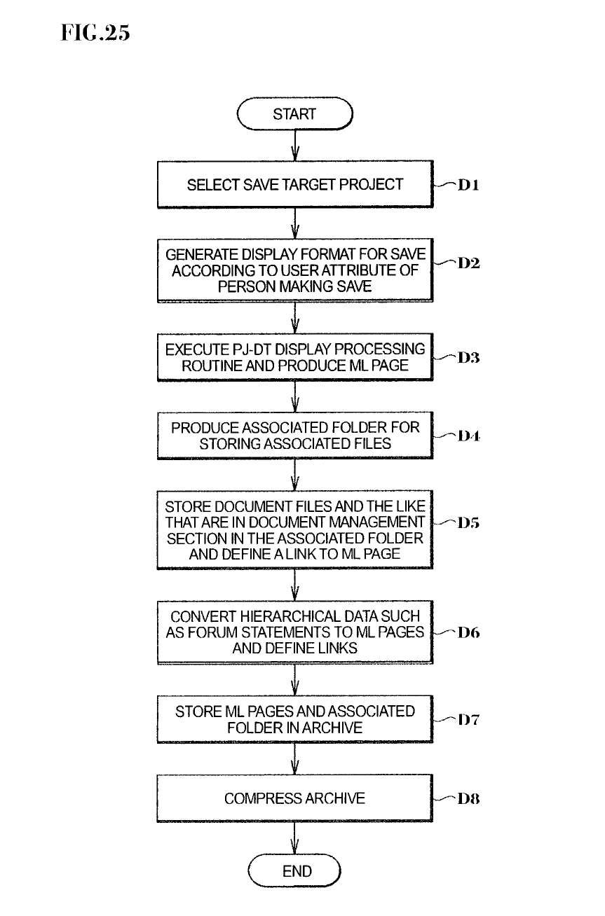

FIG. 25 is a flowchart representing one example of a project desktop save processing routine. The processing routine diagrammed in FIG. 25 constitutes an example of the operations of the save target setting unit 171 and the archive file archiving controller 172. First, the save target project is selected in response to an operation affecting a page such as that diagrammed in FIG. 24(A) (step D1). Following that, a display format is set for the save according to the user attribute of the user that is to be making the save (step D2). Then a markup language (ML) page is generated in the same manner as in the project desktop page display processing routine (step D3). In parallel with this step D3, an associated folder for storing associated files associated with the project desktop is made (step D4), the document files and the like in the bookshelf section 38 are stored in that associated folder, and a link to the ML page is also defined (step D5).

Following thereupon, when there is a forum section 36, hierarchical data such as forum statements and the like are converted to ML pages and links are defined (step D6). The ML pages and associated folders are stored in an archive (step D7), and that archive is compressed (step D8).

Personal Desktop

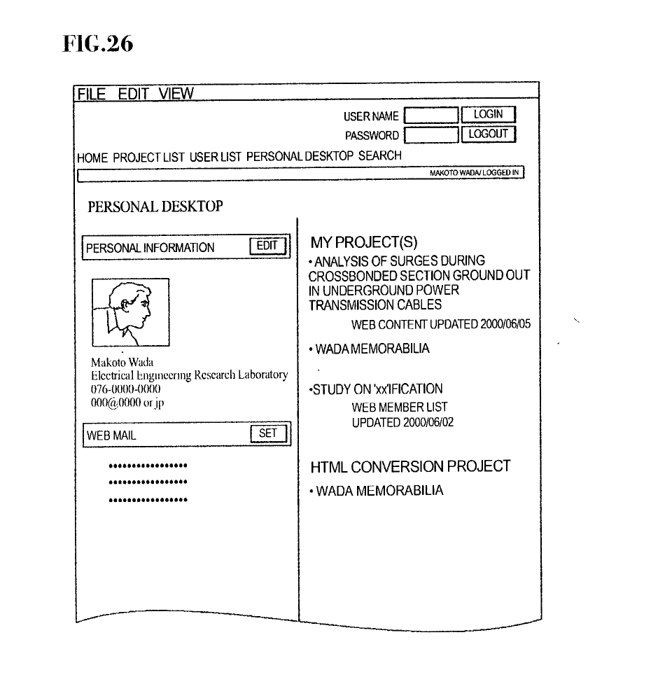

FIG. 26 is an explanatory diagram of one example of a personal desktop according to this example. Provision is made in this example so that, as diagrammed in FIG. 26, a list of the projects one belongs to can be displayed, and the project desktop can be immediately displayed. Referring once again to FIG. 8, the server comprises a personal desktop generator 132 for generating an individual personal desktop for each user. This personal desktop generator 132 in turn comprises a list of projects belonged to section generator 132A for referencing the project user table 254, when a personal desktop display request is received from a user, and generating a list of projects belonged to section that displays a list of the projects which that user belongs to, and a modification notification function 132B that, when there has been a modification made to the contents of a project in the project list generated by the list of projects belonged to section generator 132A, adds an indication of the presence or absence of that modification to that project list section.

The list of projects belonged to section generator 132A, by referencing the project user table 254, fetches the IDs of all projects which that user belongs to. In the example diagrammed in FIG. 26, furthermore, the project table is referenced, a project title is fetched from a project ID, and that project title is drawn in the personal desktop as a link to a project desktop. Provision may also be made so that, in an example where a modification log is managed in each project desktop, when that project desktop is subjected to modification within a certain period of time from the present, a display will be appended to notify of the fact that there has been a modification in a link displayed as a project name in a personal desktop. In the example diagrammed in FIG. 26, for example, “New content update, date and time” is displayed. Provision may also be made for displaying updated contents section names or displaying the names of persons making modifications. In the personal desktop, it is possible to edit personal information substituted in the project desktops, and to access the web mail functions given to log-in users.

Project List Page

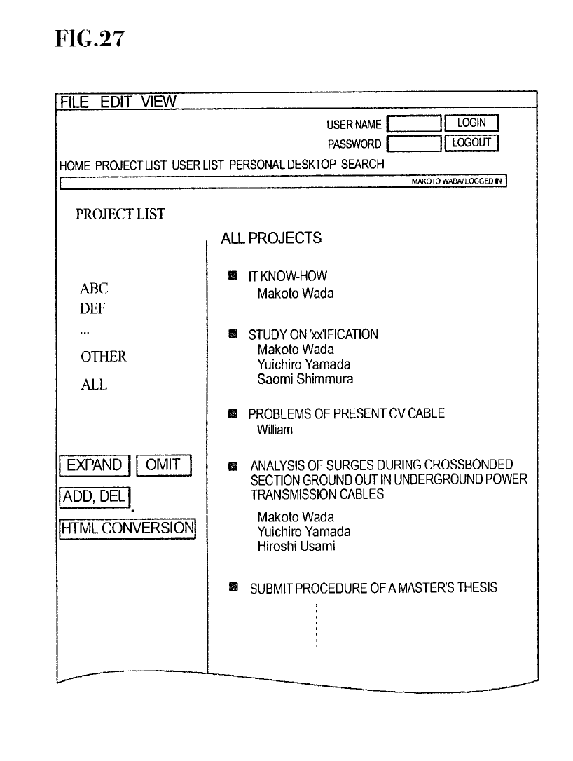

Referring yet again to FIG. 8, the server 2 comprises a project list page generator 133 for generating a project list as a project list page. Moreover, that project list page generator 133 in turn comprises a user name adding function 133A for referencing the project user table 254 and adding the names of users belonging to the projects to each of the projects respectively on that project list page. FIG. 27 is an explanatory diagram of one example of a project list page according to this example. In the example diagrammed in FIG. 27, when the expand button has been operated, the names of members belonging to projects are added to the project list display by the user name adding function 133A.

User List Page

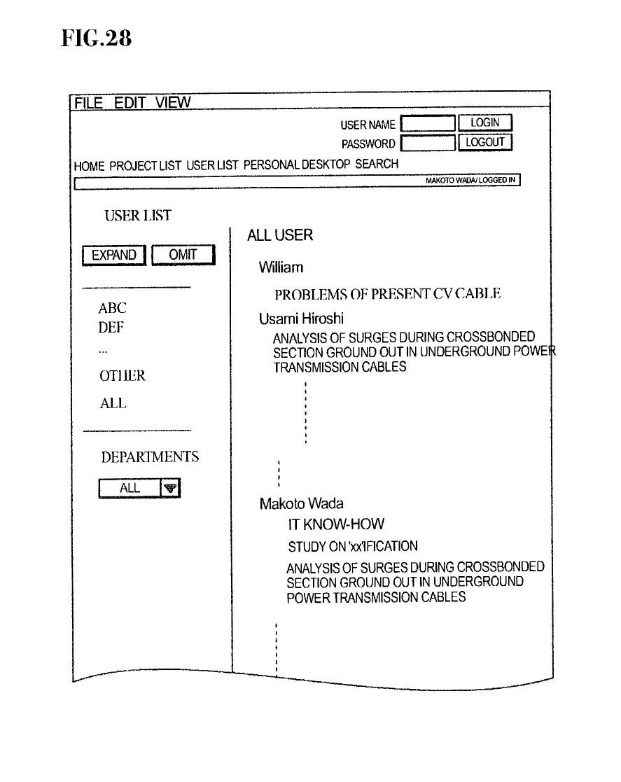

Referring to FIG. 8, the server 2 comprises a user list page generator 134 for generating a list of users as a user list page. Moreover, that user list page generator 134 in turn comprises a project name adding function 134A for referencing the project user table 254 and adding the names of projects to which the users belong to each of the users respectively in that user list page. FIG. 28 is an explanatory diagram of one example of a user list according to this example. When the expand button indicated in FIG. 28 has been operated, in the same manner as in the case diagrammed in FIG. 27, the names of projects to which a user belongs are added to that user name by the project name adding function 134A.

Examples of Use

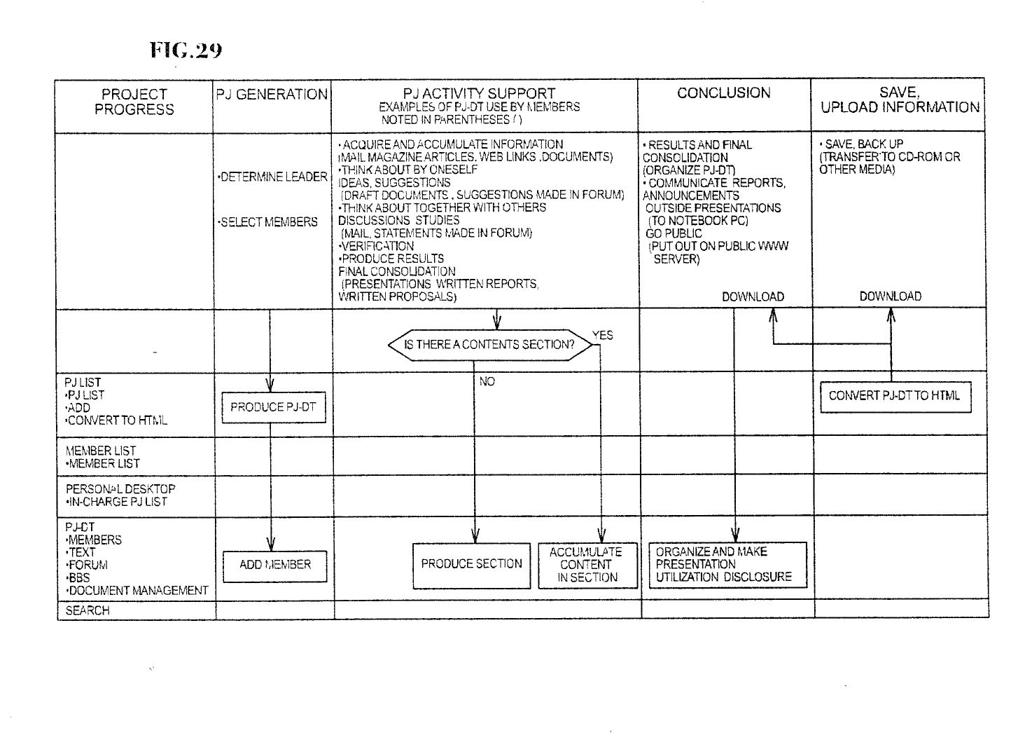

FIG. 29 is an explanatory diagram representing the general course of processes up until a project desktop is completed according to this example. In terms of everything from the inception of a project, to the generation and verification of ideas using the project desktop, the utilization of the project desktop converted to HTML and saved at project completion, and the definite safekeeping of information after project completion, with the project management system according to this example, the project desktop grows as the project progresses, and, thereby, a tighter cognizance of the way in which the project is progressing is fostered. In addition, because information relating to project activity and the activity history are recorded electronically as a project desktop, everything from presentations wherein that saved project desktop was used to the saving of information and the like can be done easily and intuitively. In other words, information collected and results produced by project members are consolidated and increasingly perfected in the project desktop, wherefore information management that accords with the progress of the project can be easily effected.

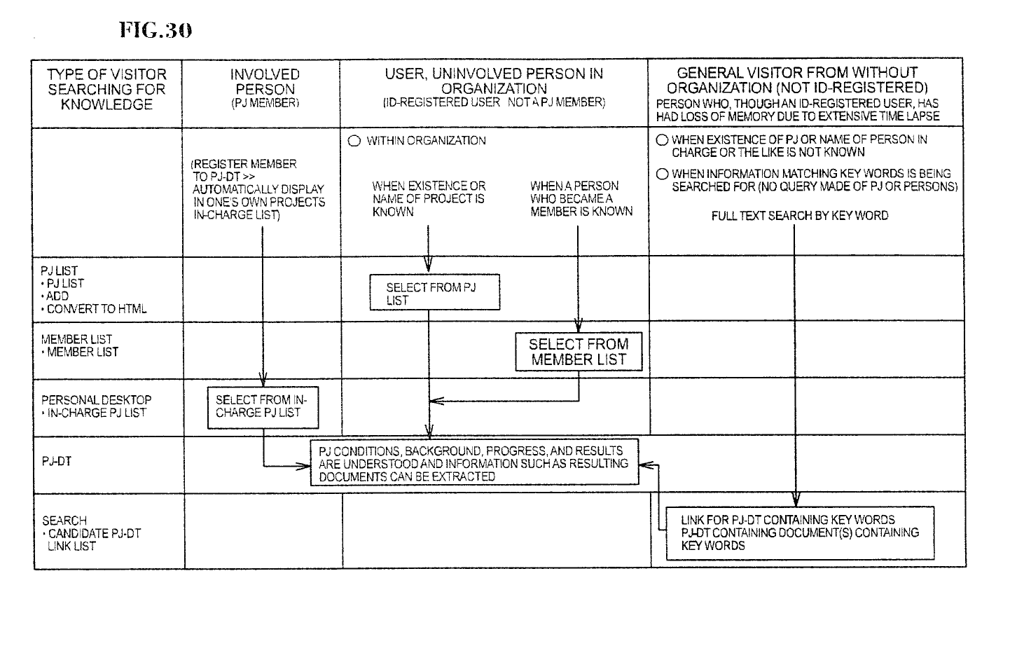

FIG. 30 is an explanatory diagram of access to a project desktop according to this example. In this example, access paths to a project desktop are provided for various users. For example, for the person himself or herself belonging to the project, a link to the project desktop is automatically displayed on his or her personal desktop, selection from a list of projects oriented to users who know the project names in an organization is made possible, and, even when the project name is unknown or has been forgotten, that project can be inferred from the member list when persons who have become members are known. Also, various searches by key words, from full text searches of document files to searches of text sections, are made possible to users or general visitors outside the organization who are interested in a specific field. In examples where links to project desktops are displayed as the search results of such searches, moreover, it becomes easy for the person making the search to access the information originally aimed at. Even in cases where the existence of a project or member names or the like have been forgotten or are not known, full text searches by key word are possible, thus facilitating ready access to information pertaining to projects.

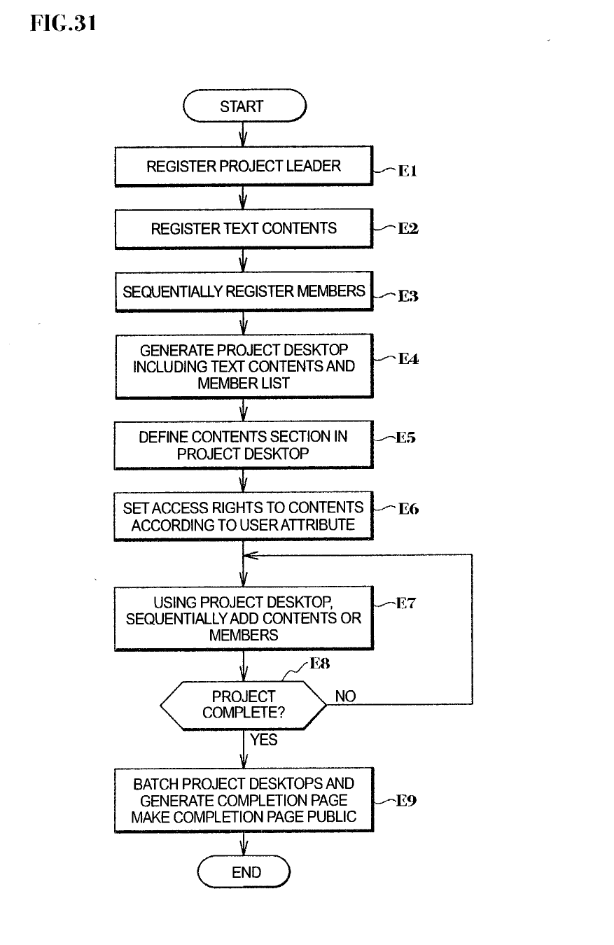

FIG. 31 is a flowchart representing an example of using the project management system according to this example. The example diagrammed in FIG. 31 is one example of putting the project management system to good use, but there are other utilization examples, besides that diagrammed in FIG. 31, adapted to various situations and organizations. The utilization example in FIG. 31 is one that emphasizes the process of project desktop growth.

First, the project initiator is registered as the leader (step E1). Following that, the content and so forth of the project are registered by the leader (step E2). If the project involves research, the particulars of the research and the problems addressed and the like should be described. If the project involves the development of a new product, the technical presuppositions, market peculiarities, and so forth, should be described, as well as guidelines for project advancement. Following that, members selected by the leader are sequentially registered to form a member list (step E3). In this example, the project leader registers the members. Members can register themselves for a project wherein there are log-in users in cases where the overall project desktop settings for the members have been made such that writes are enabled.

Following that, contents sections that manage other contents are defined in the project desktop for each project having text contents and a member list (step E4). What kind of contents are to be added to a project desktop will be determined by the leader or, when permitted by the leader, by members. Such contents should be such as document management contents for managing document files, and forum contents for recording the content of statements made by the leader and members. The access rights to the contents in each contents section are then set according to the user attributes of the leader, the members, and other users (step E5). This means that both forums that are made secret to non-member users and open forums can be produced on the same desktop. It is also possible, while openly disclosing the content of and statements made in forums, to prohibit reading out (downloading or copying) document files in the bookshelf section.

Then, in the example diagrammed in FIG. 31, a project desktop is displayed, in response to a request to display a project desktop containing contents sections, wherein the display of and operations pertaining to the various contents are limited by the specific attribute of the user making that display request, and contents input in response to that display are added to that project desktop (step E6). This step E6 is repeated until the project is completed. Then, upon completion of the project, a completion page is generated wherein text data, statement content, and document files related to that project are batched together and described with a markup language (step E8). When a completion page (in the example described in the foregoing, a project desktop (ML page) wherein are accommodated document files) is generated in this way, the project desktop can be loaded into a computer such as a portable notebook computer, and a presentation given in a conference room or the like at another institution while referring to that project desktop. Alternatively, if the project desktop is converted to HTML, it may be made public, without further modification, on a web server, making it possible to disclose information relating to a project to the outside. Thus the completion page is made public.

1. A project management system including:
a server connected by a network to a plurality of user terminals operated respectively by a plurality of users; and
a database for storing contents contained in each project participated in by some or all of the plurality of users, the contents contained in those projects are stored;
wherein, the server includes:
(a) a communication controller for transmitting pages to the user terminals and receiving operation messages from the pages;
(b) a project desktop (PJ-DT) sheet generator for reading contents data from the database in response to the operation messages and generating, for each project, a page as a project desktop for displaying or accessing all contents belonging to the project; and
(c) an access controller for, when an access has been made for content of the contents via the communication controller, controlling communications with the user terminals in unit of the project desktop containing the contents.

2. The system of claim 1 wherein the project desktops have member lists containing list information for members belonging to those projects.

3. The system of claim 1 wherein the server further includes:
(d) a project-oriented user attribute detector for detecting user attributes for projects such as leaders, members or the like of those projects set for each of the projects for users communicating via the communication controller; and
(e) a contents-oriented access controller for controlling content of operations pertaining to the project desktops based on user attributes detected and on user attribute-oriented access rights predetermined for each set of contents in the projects.

4. The system of claim 3 wherein the project desktop (PJ-DT) sheet generator (b) includes:
(b-i) a member list section generator for generating, as the contents, a member list section for managing a list of members contained in the project;
(b-ii) a forum section generator for generating, as the contents, a forum section for recording or displaying statements or replies of users in accordance with user attribute-oriented access rights controlled by the contents-oriented access controller (e);
(b-iii) a bookshelf section manager for generating, as the contents, a bookshelf section for registering or downloading files in accordance with user attribute-oriented access rights managed by the contents-oriented access controller (e) and document files registered in that bookshelf section; and
(b-iv) an access rights registration manager for, when these several contents are generated, prompting user performing those generation operations to set user attribute-oriented access rights to those contents.

5. The system of claim 4 wherein the server further includes:
(f) a save target selector for setting one or a plurality of the plurality of projects as a save target;
(g) an archive file upload manager for archiving contents contained in one or a plurality of project desktops set by the save target selector (e) in one archive file; and
(h) an archive file download manager for transmitting the archive file archived by the archive file upload manager to the user terminals in response to operations at those user terminals.

6. The system of claim 1 wherein the access controller (c) includes:
(c-i) a contents search function for searching one or a plurality of sets of contents containing data coinciding with data entered at the user terminals;
(c-ii) a project identify function for identifying projects to which contents searched by the contents search function belong; and
(c-iii) a PJ-DT list transfer function for transmitting a list of project desktops for projects identified by the project identify function, as search results, to the user terminals.

7. A method for supporting generation and management of data relating to projects, using a project management system, having a server connected by a network to a plurality of user terminals operated respectively by a plurality of users, and a database for storing contents belonging to each of projects participated in by some or all of the plurality of users,
wherein the method comprises the steps of:
(a) registering contents contained in projects for each of the projects;
(b) generating, when one or a plurality of the sets of contents registered have been searched or an access has been made concerning a member belonging to a project, a list of projects including those contents or member; and
(c) generating, when a project display request has been made by the user in response to that generated project list, a page for displaying or accessing all contents contained in that project, as a project desktop sheet.

8. The method of claim 7, wherein the project desktop generating step (c) comprises the steps of:
(c-i) detecting user attributes to determine whether or not user making the display request is a member of that project;
(c-ii) specifying displays and operations permitted to that user for several contents in accordance with user attribute-oriented access rights predetermined for each set of contents of the project for which the display request was made and with attribute of user making that display request; and
(c-iii) generating contents sections according to the determined display- and operation-related rights, and generating a page wherein those contents sections are integrated as a project desktop sheet.

9. A computer program product having a recording medium for supporting generation and management of data relating to projects, using a project management system, having a server connected by a network to a plurality of user terminals operated respectively by a plurality of users; and a database for storing contents belonging to each of projects participated in by some or all of the plurality of users;
wherein the program causes the server to:
(a) register contents contained in projects for each project;
(b) generate, when one or a plurality of the sets of contents registered have been searched or an access has been made concerning a member belonging to a project, a list of projects including those contents or member; and
(c) generate, when a project display request has been made by the user based on a project list generated by the server in response to that project list generate instruction, a page for displaying or accessing all contents contained in that project, as a project desktop.

10. A project management system including a server connected by a network to a plurality of user terminals operated respectively by a plurality of users; and a database, for each project participated in by some or all of the plurality of users, wherein contents contained in those projects are stored;
wherein the server includes:
(a) means for transmitting pages to the user terminals and receiving operation messages from the pages;
(b) means for reading contents data from the database in response to the operation messages and for generating, for each project, a page as a project desktop for displaying or accessing all contents belonging to that project; and
(c) means for, when an access has been made for content of the contents via the communication controller, controlling communications with the user terminals in unit of the project desktop containing the contents.

11. A project management system including a server connected by a network to a plurality of user terminals operated respectively by a plurality of users; and a database for storing contents contained in those projects for each of projects participated in by some or all of the plurality of users,
wherein the server includes:
a communication controller for transmitting prescribed pages to the user terminals, and receiving operation messages from the pages; and
a project desktop sheet generator for reading contents data from the database in response to operation messages received by the communication controller and generating, for each project, a page as a project desktop for displaying or accessing all contents belonging to the project; and
the project desktop sheet generator comprises functions for generating a project desktop containing, as the contents, a text section for displaying text, a forum section for recording and displaying user statements, and a bookshelf section for managing files transferred from user terminals.

12. The system of claim 11 wherein the database includes:
a project user table in which user attributes, for projects, of leaders or members or the like of the projects, set for each of those projects are recorded; and
a project contents table in which the user attribute-oriented access rights are recorded for each set of contents belonging to projects;
wherein the server includes:
a project-oriented user attribute determinator for using the project user table and determining, for users in communications via the communication controller, attributes relating to projects which are objects of those communications;
a contents-oriented access controller for controlling display and operation content pertaining to several contents of the project desktop, based on the attributes determined for projects of accessing users and on the user attribute-oriented access rights recorded in the project contents table;
wherein, the project desktop sheet generator has a function of generating a member list section for displaying or adding a list of members for each project desktop based on a list of the members belonging to projects stored in the project user table.

13. The system of claim 11, wherein,
the database includes a project table in which are recorded the user attribute-oriented access rights for the project desktop overall; and
wherein, the server includes a project-oriented access setting unit for setting access rights to the project desktop based on user attributes determined by the project-oriented user attribute determinator.

14. The system of claim 13 wherein,
the project contents table has contents order data wherein are recorded display order of contents belonging to that project in the project desktop;
wherein, the project desktop sheet generator includes:
a contents section drawing function for reading out contents such as the text based on the contents order data and sequentially drawing a contents section in accordance with access rights set by the contents-oriented access controller; and
a synthesis control function for effecting control to synthesize the contents sections drawn by the contents section drawing function in order according to the contents order data as a single-page project desktop.

15. The system of claim 11 wherein the database includes a document table in which are stored the locations where document files transmitted via the bookshelf section of the project desktop are stored, etc., and a document folder table in which are stored virtual deployment positions in the bookshelf section for the document files managed by that document table;
wherein, the server includes a document manager for storing the document files transmitted via the bookshelf section in the document table and deploying those document files in a virtual directory in the bookshelf section; and
wherein, the document manager includes a document operation control function for copying and deleting document files in accordance with user attribute-oriented access rights set by the contents-oriented access controller and for submitting those document files for downloading to the user terminals.

16. The system of claim 15, wherein
the server includes:
a save target setting unit for setting one or a plurality of the plurality of projects as save targets;
an archive file archiving controller for archiving contents contained in the one or the plurality of project desktops set by the save target setting unit, in one archive file; and
an archive file transmission controller for transmitting archive files archived by the archive file archiving controller, in response to operations at the user terminals, to those user terminals; and
wherein the archive file archiving controller includes:
a project desktop page generator for generating project desktop pages wherein contents content displays or links to portions of contents are written with a prescribed markup language, for each of the projects, in accordance with access rights set by the contents-oriented access controller;
a file storage function for storing image data used in that project desktop page and document files stored in the document table in an associated folder; and
an archive compression function for storing the project desktop page and content of the associated folder in one archive.

17. The system of claim 11, wherein
the database includes:
a project contents table in which are stored lists of the projects and contents contained in those projects;
a document table in which are stored locations where document files transmitted via the bookshelf section of the project desktop are stored, etc.; and
a document folder table in which are stored virtual deployment positions in the bookshelf section for document files managed by that document table 260; and
wherein the server includes:
a search unit for implementing searches, in response to operations at the user terminals, across the various projects, of contents in those projects and of document files managed by the document table, and specifying contents titles or document titles as search results;
a first project specifying unit that references the project contents table using contents titles searched out by that search unit, and specifies projects to which those contents belong;
a second project specifying unit that references the document table and the document folder table using document titles searched out by the search unit, and specifies projects to which those documents belong; and
a list transmission controller for transmitting a list of projects specified by the first and second project specifying units to the user terminals, as search results of the search unit, in a condition of being linked to the project desktop.

18. The system of claim 17 wherein the list transmission controller includes functions for determining user attributes of users who performed the search operations for the specified projects, and for removing projects which cannot be displayed to those users from the specification results.

19. The system of claim 11, wherein
the database includes a project user table, for each of the projects, wherein is stored a list of users belonging to that project; the server includes a personal desktop generator for generating an individual personal desktop for each of the users; and
the personal desktop generator includes:
a list of projects belonged to section generator for referencing the project user table, when personal desktop display requests are received from users, and generating a list of projects belonged to section that displays a list of the projects which those users belong to; and
a modification notification function that, when there has been a modification made to the contents of a project in the project list, adds and indication of the presence or absence of that modification to that project list section.

20. The system of claim 19, wherein the server includes a project list page generator for generating the project list as a project list page; and that project list page generator includes a user name adding function that references the project user table and adds names of users belonging to projects to each of several projects respectively on that project list page.

21. The system of claim 19 wherein the server includes a user list page generator for generating a list of the users as a user list page; and that user list page generator includes a project name adding function for referencing the project user table and adding names of projects to which users belong to each of various users respectively in that user list page.

22. A recording medium for recording project management data thereon, which data are used by a project management system,
wherein the system includes:
a server connected by a network to a plurality of user terminals operated respectively by a plurality of users; and
a database, for each project participated in by some or all of the plurality of users, wherein contents belonging those projects are stored; and
wherein the project management data include:
a user table in which are stored user IDs of the plurality of users, respectively;
a project table in which are stored project IDs for identifying the plurality of projects, a project title for each of those project IDs, and user attribute-oriented access rights for those projects;
a project user table in which are stored the user IDs of users belonging to the projects, and order of users which constitutes the user attributes;
a contents table in which are recorded types of contents of forum section or bookshelf section or such like which are generated for each of the projects; and
a project contents table in which are recorded contents IDs of contents belonging to the projects, user attribute-oriented access rights to the several contents, and display order of several contents;
the project user table is used, when a project desktop is generated by the server, to determine user attribute of a user making a request to display that project desktop; and
the project contents table is used both to determine the contents display mode in accordance with the user attribute-oriented access rights, and to specify the display order for the several contents.

23. A method for supporting activities in project units, using a computer, comprising the steps of:
registering project originator as leader thereof;
registering content, etc., of that project input by the leader as text contents;
sequentially registering members selected by the leader to form a member list;
defining contents sections for managing other contents in project desktop for each project having the text contents and the member list;
registering access rights to several contents in each contents section in accordance with attributes of leader, members, and other users;
displaying a project desktop, in response to a request to display a project desktop containing the contents sections, wherein display of and operations pertaining to various contents are limited by user attribute of user making that display request, and adding contents input in accordance with that display to that project desktop;
generating a completion page wherein text data, statement content, and document files related to that project are batched together and described with a markup language; and
making that completion page public.

24. The method in claim 23, wherein the contents sections include: document management contents for managing document files; and forum contents for recording content of statements made by leaders and members.
